(19) United States
(12) Patent Application Publication
(10) Pub. No.: US 2008/0246389 A1
(43) Pub. Date: Oct. 9, 2008

(54) Systems and Methods for Front Contacts for Electroluminescent Apparatus and Flexible Display

(76) Inventors: Drew Fredrick Meincke, Woodstock, GA (US); Richard C. Cope, Duluth, GA (US); Aris K. Silzars, Sammamish, GA (US); Brent K. Wagner, Marietta, GA (US)

Correspondence Address: SUTHERLAND ASBILL & BRENNAN LLP, 999 PEACHTREE STREET, N.E., ATLANTA, GA, 30309, US

(21) Appl. No.: 11/681,960

(22) Filed: Mar. 5, 2007

Related U.S. Application Data
(63) Continuation-in-part of application No. 11/526,661, filed on Sep. 26, 2006.

(51) Int. Cl. H01J 1/62; H01J 9/02

(52) U.S. Cl. 313/503; 445/24

(57) ABSTRACT

Systems and methods are provided for front contacts utilized with electroluminescent displays. The method includes arranging a plurality of electroluminescent elements, where each electroluminescent element includes at least one top electrode, and where the electroluminescent elements are operable to emit electroluminescence from the top electrode, and providing a conductive layer, where the conductive layer is flexible and substantially transparent. The method further includes adhering the conductive layer to a first top electrode of a first electroluminescent element of the plurality of electroluminescent elements and to a second top electrode of a second electroluminescent element of the plurality of electroluminescent elements. The system includes a flexible support structure and a plurality of electroluminescent elements arranged on the flexible support structure, where each electroluminescent element includes at least one top electrode, and where the electroluminescent elements are operable to emit electroluminescence from the top electrode. The system further includes a conductive layer, where the conductive layer is flexible and substantially transparent and where the conductive layer is electrically connected to a first top electrode of a first electroluminescent element of the plurality of electroluminescent elements and a second top electrode of a second electroluminescent element of the plurality of electroluminescent elements.

### RELATED APPLICATIONS

The invention is a continuation-in-part of U.S. application Ser. No. 11/526,661, filed Sep. 26, 2006, and entitled “Electroluminescent Apparatus and Display Incorporating Same.” which is hereby incorporated by reference in its entirety as if fully set forth herein.

### FIELD OF INVENTION

The invention relates generally to electroluminescent displays, and more particularly, to front contacts for electroluminescent elements of a flexible electroluminescent display.

### BACKGROUND OF INVENTION

Electroluminescence (EL), a well-known phenomenon commonly exploited in flat panel displays, is the conversion of electrical energy to light via the application of an electrical field to a phosphor. Commonly used EL devices include Light Emitting Diodes (LEDs), laser diodes, and EL displays (ELDs). Typically, an ELD is in the form of a thin film electroluminescent (TFEL) device, which is a solid-state device generally comprising a phosphor layer positioned between two dielectric layers, and further includes an electrode layer on the surface of each dielectric layer to form a five-layer structure wherein the electrode layers define the outer layers and the phosphor layer defines the inner middle layer. When a sufficiently high voltage is applied to the electrode layers, the inner phosphor layer is subjected to an electric field which causes the phosphor layer to emit light.

In matrix-addressed EL displays, the electrode layers comprise orthogonal rows and columns of conductive material arranged in such a manner that the top electrode layer contains spaced-apart rows of conductive material and the bottom layer contains spaced-apart columns of conductive material orthogonally arranged with respect to the rows. Voltage drivers can be used to apply predetermined voltages to the various rows and columns, causing the EL phosphor in the overlap area between the rows and columns to emit light when sufficient voltage is applied.

Current EL panels typically include glass substrates that are rigid and not flexible. Likewise, current front contacts are for the top electrode layers are similarly rigid and not flexible, and thus, are not suitable for flexible EL panels.

### SUMMARY OF INVENTION

Systems and methods are provided for front contacts for electroluminescent elements of an ELD. These front contacts may be (i) visually/optically transparent, (ii) adhered to the top electrodes, (iii) flexible, and (iv) conductive, according to embodiments of the present invention.

According to an embodiment of the invention, there is a method for providing electrical connections for an electroluminescent display. The method includes arranging a plurality of electroluminescent elements, where each electroluminescent element includes at least one top electrode, and where the electroluminescent elements are operable to emit electroluminescence from the top electrode. The method further includes providing a conductive layer, where the conductive layer is flexible and substantially transparent, and adhering the conductive layer to a first top electrode of a first electroluminescent element of the plurality of electroluminescent elements and to a second top electrode of a second electroluminescent element of the plurality of electroluminescent elements.

According to another embodiment of the invention, there is an electroluminescent display. The display includes a flexible support structure and a plurality of electroluminescent elements arranged on the flexible support structure, where each electroluminescent element includes at least one top electrode, and where the electroluminescent elements are operable to emit electroluminescence from the top electrode. The display further includes a conductive layer, where the conductive layer is flexible and substantially transparent and where the conductive layer is electrically connected to a first top electrode of a first electroluminescent element of the plurality of electroluminescent elements and a second top electrode of a second electroluminescent element of the plurality of electroluminescent elements.

According to still another embodiment of the invention, there is an electroluminescent display. The display includes means for arranging a plurality of electroluminescent elements, where each electroluminescent element includes at least one top electrode, and where the electroluminescent elements are operable to emit electroluminescence from the top electrode. The display further includes means for electrically connecting a first top electrode of a first electroluminescent element of the plurality of electroluminescent elements to a second top electrode of a second electroluminescent element of the plurality of electroluminescent elements, wherein the means for electrically connecting is flexible and substantially transparent.

### BRIEF DESCRIPTION OF THE DRAWINGS

FIG. 1 shows a nixel in an ELD in accordance with an exemplary embodiment of the invention.

FIG. 2 shows a cross-section of a nixel in accordance with an exemplary embodiment of the invention.

FIG. 3 shows a flowchart of a method in accordance with an exemplary embodiment of the invention.

FIG. 4 shows a cross-section of a nixel in accordance with an exemplary embodiment of the invention.

FIG. 5 shows a flowchart of a method in accordance with an exemplary embodiment of the invention.

FIGS. 6A-6I illustrate the stages of a method in accordance with an exemplary embodiment of the invention.

FIG. 7 shows variably-shaped nixels in accordance with an exemplary embodiment of the invention.

FIG. 8 shows a flowchart of a method in accordance with an exemplary embodiment of the invention.

FIG. 9 shows a multicolor nixel in accordance with an exemplary embodiment of the invention.

FIG. 10 shows a flowchart of a method in accordance with an exemplary embodiment of the invention.

FIG. 11 shows a method in accordance with an exemplary embodiment of the invention.

FIG. 12 shows a flowchart of a method in accordance with an exemplary embodiment of the invention.

FIG. 13 shows a flowchart of a method in accordance with an exemplary embodiment of the invention.

FIG. 14 shows a flowchart of a method in accordance with an exemplary embodiment of the invention.

FIG. 15 shows a flowchart of a method in accordance with an exemplary embodiment of the invention.

FIG. 16 shows an ELD in accordance with an exemplary embodiment of the invention.

FIG. 17 shows an ELD in accordance with an exemplary embodiment of the invention.

FIG. 18 shows an apparatus in accordance with an exemplary embodiment of the invention.

FIGS. 19A-19G show a method of making an ELD in accordance with an exemplary embodiment of the invention.

FIGS. 20A-20F show a method of making an ELD in accordance with an exemplary embodiment of the invention.

FIGS. 21A-21F show an exemplary method of making an ELD in accordance with an exemplary embodiment of the invention.

FIGS. 22A-22D show a method of making an ELD in accordance with an exemplary embodiment of the invention.

FIGS. 23A-23B show a method of making an ELD in accordance with an exemplary embodiment of the invention.

FIGS. 24A-24E and 26A-26M show illustrative front contacts in accordance with exemplary embodiments of the invention.

FIGS. 25A-D and 27A-27J show exemplary methods for providing front contacts in accordance with exemplary embodiments of the invention.

### DETAILED DESCRIPTION OF EXEMPLARY EMBODIMENTS

The systems and methods of the invention produce flexible, adhesive, visually and/or optically transparent, and conductive front contacts for EL elements. According to an embodiment of the invention, these EL elements may be “nixels” as illustratively described herein, which are individually sized and modular shaped EL elements that are adapted to form part of an integrated ELD. Alternatively, the EL elements may be sphere-supported thin film phosphor electroluminescent (SSTFEL) devices, as described in WO 2005/024951 A1, published Mar. 17, 2005, and entitled “Sphere-Supported Thin Film Phosphor Electroluminescent Devices.” which is hereby incorporated by reference as if fully set forth herein. While the systems, methods, and apparatuses below for flexible, adhesive, visually/optically transparent, and conductive front contacts may be disclosed in the context of nixels, they are for illustrative purposes only. Indeed, it will be appreciated that these systems, methods, and apparatuses for flexible, adhesive, visually/optically transparent, and conductive frontal contacts may also apply to SSTFEL devices or other EL elements as well.

As required, specific embodiments of the invention are disclosed herein. It should be understood, however, that these are merely exemplary embodiments of the invention that can be variably practiced. Drawings are included to assist the teaching of the invention to one skilled in the art; however, they are not drawn to scale and may include features that are either exaggerated or minimized to better illustrate particular elements of the invention. Related elements may be omitted to better emphasize aspects of the invention. Specific structural and functional details disclosed herein are not to be interpreted as limiting, but merely as a basis for the claims and as a representative basis for teaching one skilled in the art to variously employ the invention.

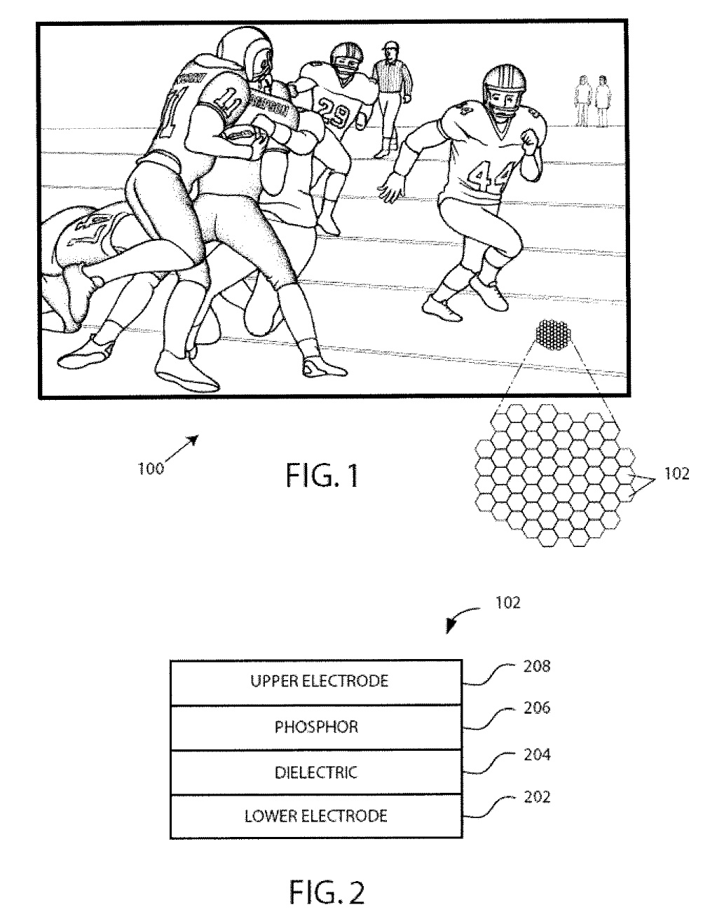

In an exemplary embodiment of the invention, a nixel may be individually manufactured and selectively positioned on a substrate to form an ELD. Referring to the figures, wherein like numbers refer to like elements throughout, FIG. 1 shows an ELD 100 of the invention which includes a nixel 102 in the form of a subpixel. In the exemplary embodiment shown in FIG. 2, a discrete EL apparatus, referred to herein as a nixel 102, includes a lower electrode 202, a dielectric layer in the form of a base material 204, a phosphor 206, and an upper electrode 208. As described in more detail below, a nixel may include additional layers and may be formed into a variety of desired shapes.

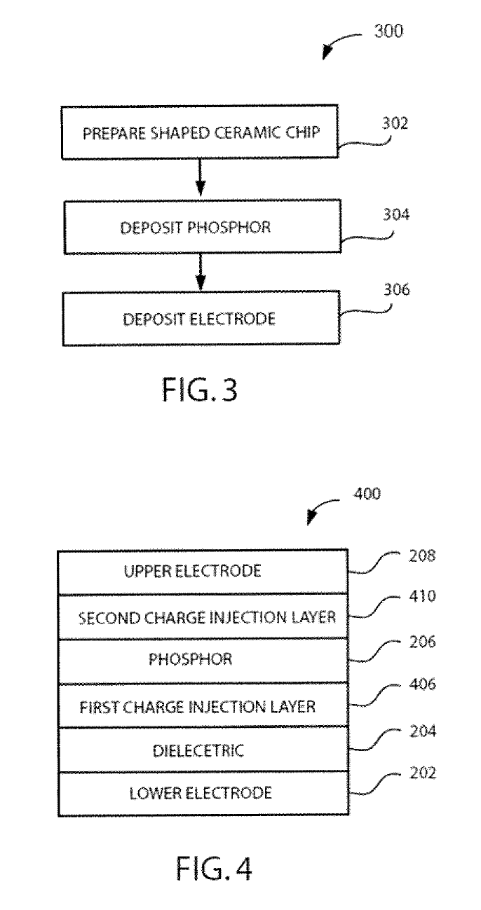

FIG. 3 shows a flow diagram of an exemplary method 300 of making a nixel 102. At block 302, a dielectric ceramic material 204 is formed into a chip of a desired shape; at block 304, a phosphor layer 206 is deposited on the chip; and at block 306, upper 208 and lower 202 electrodes are provided, thereby forming a discrete EL apparatus. The particular EL properties of the nixel 102 can be measured by applying sufficient voltage to the upper 208 and lower 202 electrodes to generate EL in the nixel 102.

FIG. 4 shows another exemplary embodiment of a nixel 400 that includes a lower electrode layer 202, a dielectric material 204, a first charge injection layer 406, a phosphor layer 206, a second charge injection layer 410, and an upper electrode layer 208. It is contemplated, however, that either one or both charge injection layers may be eliminated.

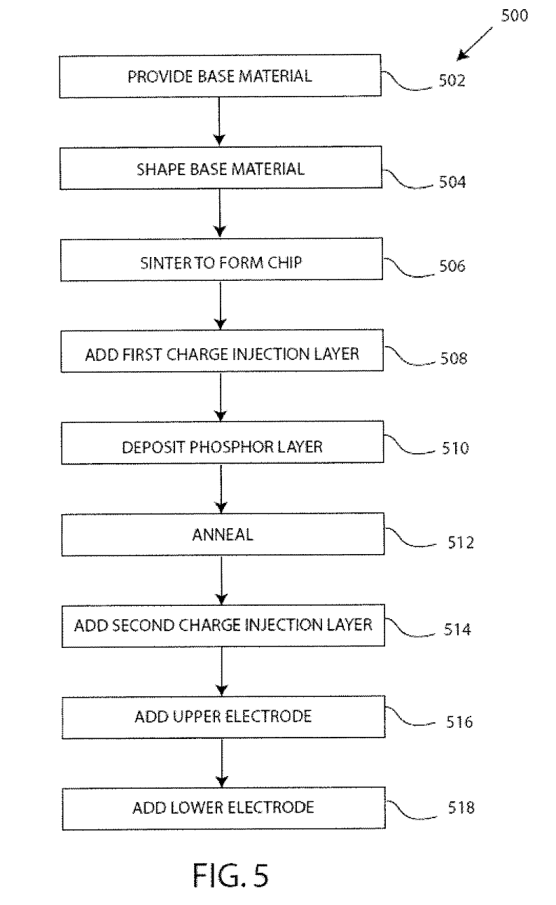

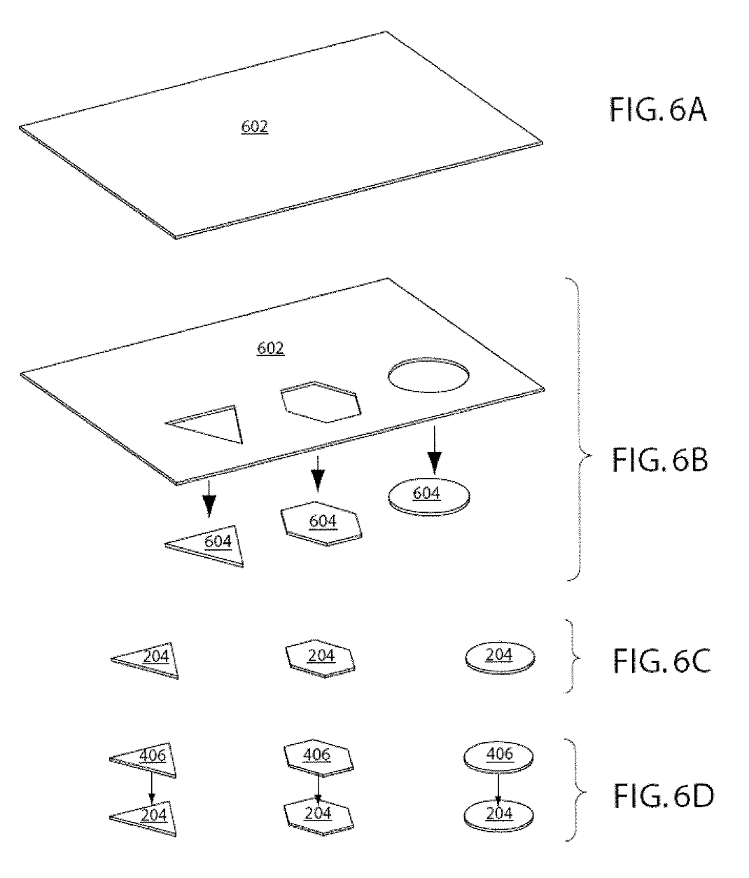

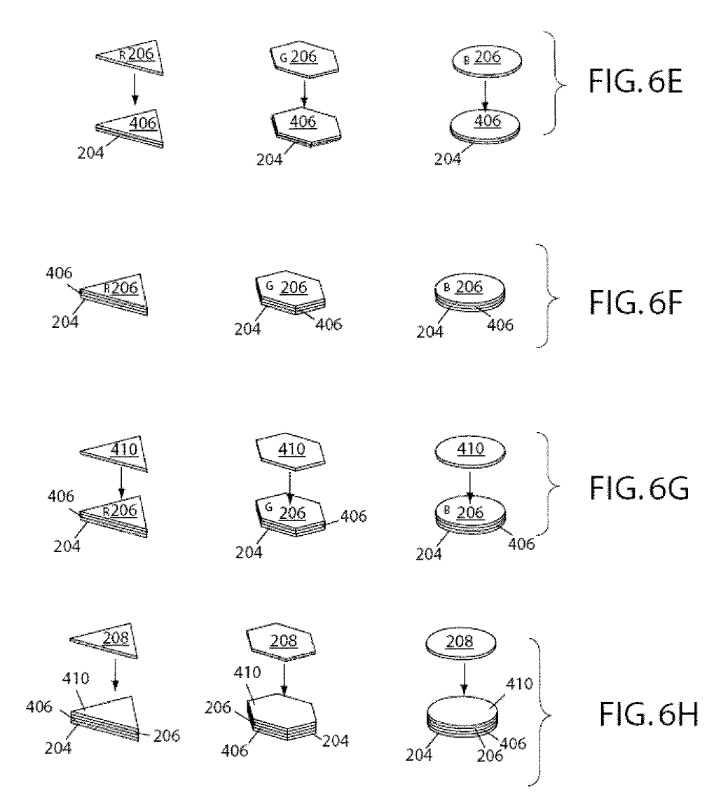

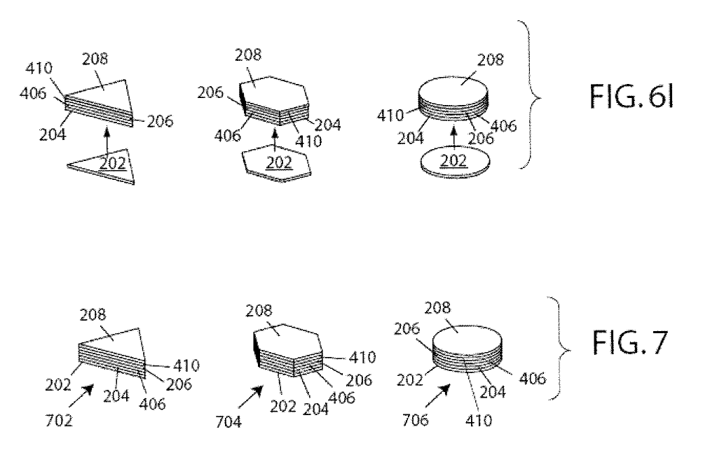

FIG. 5 shows a flow diagram of an exemplary method 500 of the invention for making the nixel 400 in accordance with an embodiment of the invention. FIGS. 6A-6H illustrate the various manufacturing stages described by the method 500. Referring to FIGS. 4, 5, and 6, at block 502, a dielectric base material 204 is provided. The base material 204 serves as a substrate upon which subsequent dielectric and phosphor layers can be deposited. In a preferred embodiment, the base material 204 is a ceramic dielectric composed of barium titanate, BaTiO₃ (BT) or barium strontium titanate, Ba_{0.5}Sr_{0.5}TiO₃ (BST). Barium titanate compounds are typically temperature-stable ceramics with relatively high dielectric constants that are commonly used in the manufacture of ceramic capacitors. Depending on the temperature and grain size. BST can have a peak dielectric constant of 18,000, making it an attractive dielectric choice. In an exemplary embodiment, a slurry composed of BT compound particles dissolved in a suitable solvent is carefully agitated and blended, then poured and pressurized on to a surface. Sufficient pressure is applied to form a thick and vertically homogeneous substance of a desired thickness and density. In an exemplary embodiment, the BT ceramic material is formed in a sheet that is approximately 200 μm thick, commonly referred to as a green sheet prior to high temperature processing. The green sheet forms a continuous length that can be cut into a shorter length by a cutting instrument, as shown in FIG. 6A by the green BT length 602. At block 504, the green BT material can be formed into predetermined shapes and sizes. In a first embodiment, a tool is used to punch out a desired shape. By way of example and not limitation, a tool could be used to punch out an oval shape, a hexagonal shape, a rectangular shape, a triangular shape, a cylindrical shape, a mushroom shape, etc., as shown by BT shapes 604 in FIG. 6B. It is contemplated that a variety of tools may be used to form non-rectangular shapes so that nixels can be shaped in accordance with various ELD requirements and applications. Thus, the shape of the nixel of the invention can be customized to satisfy desired mechanical attributes. For example, for flexible display applications, it may be desirable to have nixels with rounded edges without corners. As a result, an oval punch-out tool may be selected to punch out ovals from the green BT material. For a second type of application, it may be desirable to have hexagonal-shaped nixels, so a hexagon punch-out tool can be selected. The methods of the invention allow the operator to design a desired punch-out shape. In a further embodiment of the invention, a laser may be used to carve a desired shape from the green ceramic material. Other instruments may also be used to define and produce a desired shape, for instance a blade or die-cut tool can be used, or molded shapes using slurry cast directly into the final shape using a mold.

After the shaping process is completed, the green BT material shapes 604 are processed. In this embodiment, the shapes are sintered under monitored and controlled conditions at block 506 to produce ceramic chips 204 (FIG. 6C) of a desired density and surface smoothness to accept additional charge injection and phosphor layers. By controlling the sintering process, ceramic chips that can provide a desired dielectric result and electrical performance can be produced. In an exemplary embodiment, the ceramic chip can be sintered at temperatures ranging from 900° C. to 1200° C. for approximately 4 hours. By sintering the green BT shapes 604 prior to the deposition of charge injection and phosphor layers, and independently of the ELD support structure, concerns regarding the effects of the sintering temperatures on other materials are no longer warranted.

After the green ceramic shapes 604 have been sintered to become ceramic chips 204, charge injection, phosphor, and electrode layers may be deposited. At block 508, a first charge injection layer 406 can be deposited on the ceramic chip 204 as shown in FIG. 6D. In an exemplary embodiment, the charge injection layer 406 is an alumina layer sputtered to a thickness of around 30 nm. At block 510, a phosphor layer 206 can be deposited on the first charge injection layer 406 as shown in FIG. 6E. In an exemplar embodiment, the nixel 400 is in the form of a subpixel, which is understood to produce a single color. Because the nixel 400 is single-colored, a single phosphor can be deposited as phosphor layer 206 on the first charge injection layer 406, as shown in FIG. 6E. A variety of EL phosphors may be used, including, but not limited to metal oxide phosphors and sulfide phosphors. Such metal oxide phosphors and methods of production are described in U.S. Pat. Nos. 5,725,801; 5,897,812; 5,788,882 and U.S. patent application Ser. No. 10/552,452, which patents and application are herein incorporated by reference. Metal oxide phosphors include: Zn₂Si_{0.5}Ge_{0.5}O₄:Mn, Zn₂SiO₄:Mn, Ga₂O₃:Eu and CaAl₂O₄:Eu. Sulfide phosphors include: SrS:Cu, ZnS:Mn, BaAl₂S₄:Eu, and BaAl₄S₇:Eu. Phosphor selection may depend on many factors, including EL spectral range, required annealing temperature, and luminance values as a function of frequency and voltage. A single phosphor can be used to emit various wavelengths of light by controlling the applied signal voltages and frequencies. Alternatively, a particular phosphor can be used to emit a particular color of light. Filtering techniques can also be used to obtain a desired color.

An aspect of the invention is the ability to make individual nixels using a variety of phosphors. For example, in a first embodiment, the nixel 400 is a blue subpixel. Consequently a phosphor that can produce a bright blue color is deposited as phosphor layer 206. Examples of blue-emitting phosphors that can be deposited include. BaAl₂S₄:Eu, which is typically annealed at 750° C., and SrS:Cu, which is typically annealed at 700° C. In a further embodiment, the nixel 400 is a green subpixel. Accordingly, a green-emitting phosphor such as Zn₂Si_{0.5}Ge_{0.5}O₄:Mn, which is annealed at 800° C., is deposited on the charge injection layer 406. In yet a further embodiment, an amber subpixel is formed by depositing a layer of ZnS:Mn, while a red subpixel can be formed by depositing a layer of Ga₂O₃:Eu (See D. Stodilka, A. H. Kitai, Z. Huang, and K. Cook, SID'00 Digest, 2000, p. 11-13). The phosphor layer 206 can be deposited by magnetron sputtering techniques well-known in the art. In an exemplary embodiment, RF sputtering techniques using argon plasma are used to sputter a phosphor layer of approximately 7000 Å thick. In an alternative embodiment, thermal evaporation can be used to deposit a phosphor layer.

After the phosphor layer 206 has been deposited, an annealing procedure may be performed at block 512 to activate and crystallize the phosphor layer 206, as shown in FIG. 6F. As mentioned above, the temperature at which the phosphor layer 206 is annealed is dependent upon the type of phosphor material deposited. For example, BaAl₂S₄:Eu is annealed at 750° C. By performing the high-temperature phosphor annealing process on individual nixels at this stage of the manufacturing process, previous problems and limitations related to mechanical deformation of display support structures are avoided. For example, because BaAl₂S₄:Eu requires annealing temperatures greater than 500° C., previous manufacturing methods employed to produce glass ELDs had difficulty using the BaAl₂S₄:Eu phosphor to generate blue light. By eliminating the limitations associated with the use of glass substrates, the methods of the invention accommodate a broader array of phosphor options in the creation of ELDs. Furthermore, each nixel can be processed in accordance with its own desired characteristics.

Following the phosphor layer 206 deposition, a second charge injection layer 410 can be deposited as shown in FIG. 6G at block 514. In an exemplary embodiment, the charge injection layer 410 is composed of alumina (Al₂O₃). In alternative embodiments, the charge injection layer 410 can be composed of dielectrics such as, but not limited to BaTa₂O₅ and SiON. The selected dielectric material can be deposited on the phosphor layer 206 by sputtering techniques to form a layer of approximately 300 Å. Although shown in the figures as comprising both a first and a second charge injection layer, a nixel of the invention can also be made with a single charge injection layer located either above or below the phosphor layer, or no charge injection layer at all.

At blocks 516 and 518, upper and lower electrode layers, 208 and 202, respectively, can be formed as shown in FIGS. 6H and 6I. The upper electrode 208 can be formed using a transparent conducting material. In an exemplary embodiment, Indium Tin Oxide (ITO) containing substantially 90% by weight of In₂O₃ and substantially 10% by weight of SnO₂ is sputtered to a thickness of 150 nm to form upper electrode layer 208. In an exemplary embodiment, lower electrode layer 202 is formed from a metallic substance composed of molybdenum. In a further exemplary embodiment, lower electrode layer 202 is silver or a silver alloy. Other conducting materials may also be used to form lower electrode layer 202, which is applied to the lower surface of sintered ceramic layer 204 by evaporation, sputtering or printing. Deposition of electrode layers 202 and 208 completes the nixel manufacturing process described by FIG. 5. FIG. 7 shows several exemplary embodiments of a nixel 400 of the invention: a triangular nixel 702, a hexagonal shaped nixel 704, and an oval shaped nixel 706 are but a few of the variously shaped nixels that can be produced in accordance with the invention.

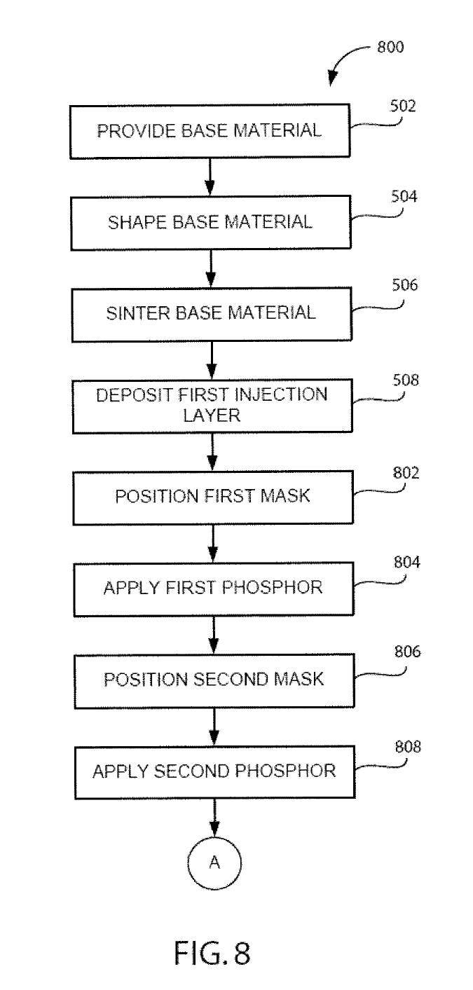

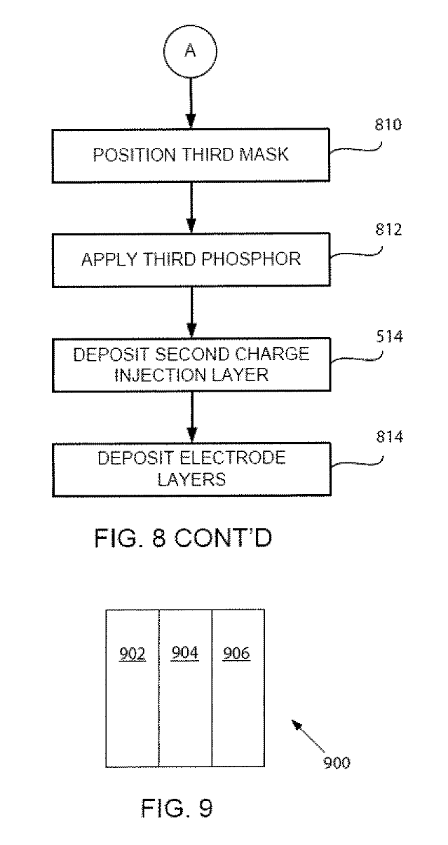

In a further exemplary embodiment of the invention, a nixel is made in the form of a multicolored EL apparatus, for example a pixel containing red, blue and green phosphors, rather than a single-colored subpixel. A method 800 of the invention for making a multicolored nixel is illustrated by the flowchart of FIG. 8. The first four blocks of the flowchart, 502, 504, 506, and 508, respectively, are the same as those shown in FIG. 5, so they will not be discussed further. After the first charge injection layer is deposited on the sintered base material at block 508, then at block 802 a first mask is positioned over the first charge injection layer to define a receiving area for a first phosphor layer. A first phosphor, for example, a red-emitting phosphor is then sputtered within the area defined by the first mask at block 804. The first mask can then be removed and a second mask positioned at block 806 so that a second phosphor, for example a blue-emitting phosphor can be deposited at block 808. At block 810, the second mask can be removed and a third mask positioned, so that a third phosphor, for example a green-emitting phosphor, can be deposited at block 812. In a preferred embodiment, the blue, red, and green phosphors are coplanar and comprise a single vertical phosphor layer of the nixel. At block 514, a second charge injection layer can be deposited on the phosphor layer. At block 814, upper and lower electrodes can be deposited as discussed above in reference to blocks 516 and 518 of method 500. Referring to FIG. 9, a multicolored nixel 900 that can be produced by method 800 is shown with a blue phosphor layer 902, a red phosphor layer 904 and a green phosphor layer 906. As mentioned earlier in the context of a single color nixel, multicolored nixels can also be produced with a single charge injection layer, multiple charge injection layers, or no charge injection layer at all.

Alternatively, the nixel-shaping process in any of the above embodiments can be performed after deposition of charge injection, phosphor and electrode layers onto the sintered chip. This shaping may be accomplished by dicing or laser cutting, among other methods.

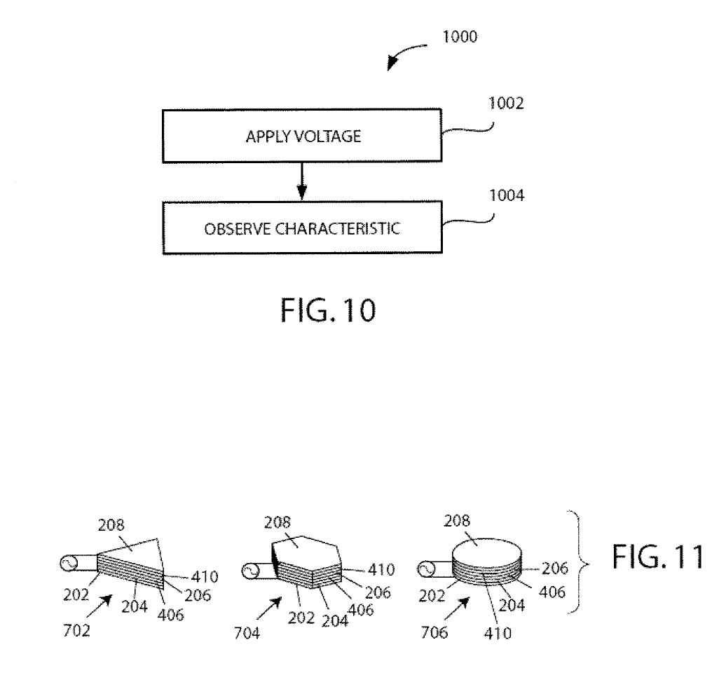

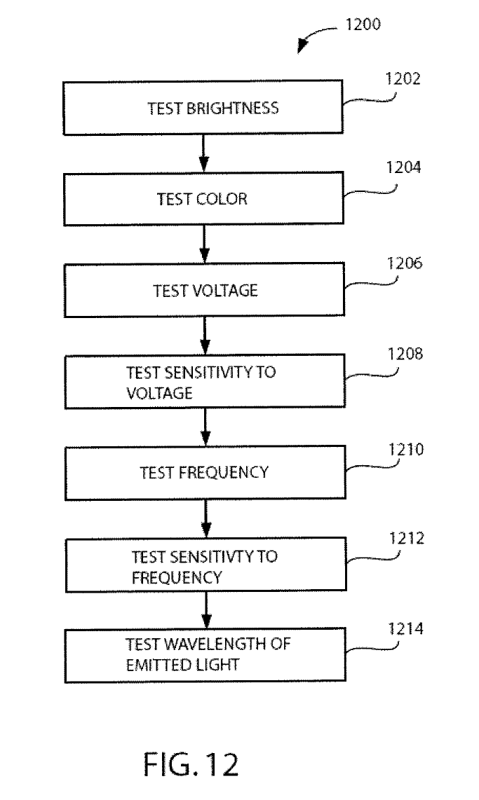

FIG. 10 shows an exemplary method 1000 of the invention. At block 1002, a voltage is applied to the nixel to cause electroluminescence; in an exemplar embodiment, a nixel may be provided by the methods 300, 500, or 800 as previously discussed, or by other means and an voltage provided to the upper electrode 208 and lower electrode 202 of the nixel so that a sufficient electric field is provided for EL. At block 1004, the nixel can be observed to determine its characteristics and performance. To determine nixel electrical characteristics, tests can be performed as known in the art, for example a voltage can be applied to the upper and lower electrodes as shown in FIG. 11, and the nixel response may be measured. As shown in FIG. 11 and by the method 1200 of FIG. 12, individual nixels 702, 704, and 706 can be tested for a variety of characteristics including but not limited to: testing brightness at block 1202, testing color point at block 1204, testing drive voltage at block 1206, testing sensitivity to drive voltage at block 1208, testing frequency response at block 1210, testing sensitivity to frequency at block 1212, and testing the wavelength of emitted light at block 1214. Other parameters of interest can also be tested to further characterize the nixels. These test procedures may be automated for increased efficiency.

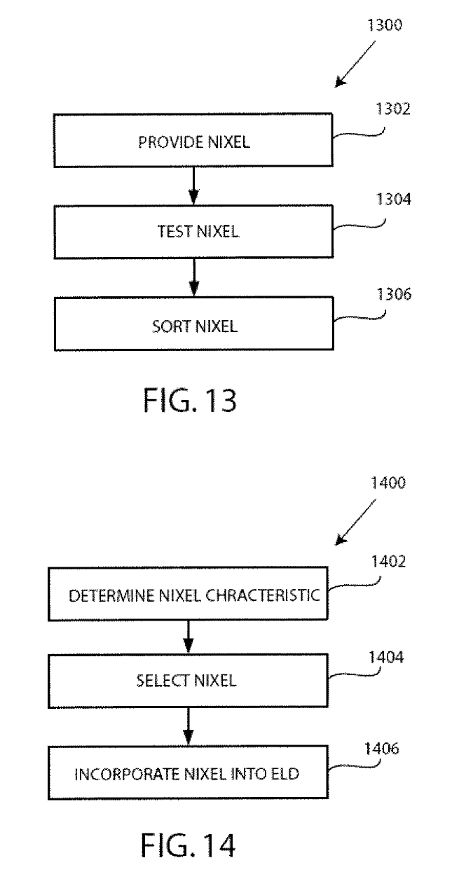

FIG. 13 shows a further method 1300 of the invention. At block 1302, a nixel is provided; in an exemplary embodiment, a nixel may be provided by the methods 300, 500, or 800 discussed above or by other means. At block 1304, the nixel can be tested to determine its characteristics as discussed above. As the nixels are tested, they can be sorted according to their characteristics and parameters at block 1306. Unsatisfactory nixels that perform below a predetermined threshold may be rejected. For example, nixels with unacceptably low brightness levels can be grouped together and discarded or utilized for other low brightness level applications. Nixels that perform within an acceptable range can be retained and grouped according to their characteristics. For example, nixels with brightness levels ranging from 800 cd/m² to 1000 cd/m² can be put in a first group. Nixels with brightness levels from 600 cd/m² to 800 cd/m² can be put in a second group, and so forth, according to predetermined specifications. By sorting and rejecting individual nixels based on their characteristics, a manufacturer can improve overall ELD quality as well as production yield by using only those nixels with proven characteristics. No longer will an operator have to wait until an ELD has been completely assembled in order to test EL device performance.

Categorizing nixels and grouping them accordingly allows a manufacturer to select nixels of a particular quality or attribute for use in a particular display. Thus, nixels can be selected for an ELD based on the intended ELD application. For example, an ELD intended for a use as a portable military display may have to satisfy certain flexibility, weight, and brightness requirements. Accordingly, nixels that perform well in a small, thin, flexible ELD structure can be chosen. Both mechanical and electrical attributes may be considered when selecting appropriate nixels. For example, nixel shapes with rounded edges may be preferred to improve flexibility, and nixels with high luminosity values may be selected to improve visibility for the portable military display. On the other hand, for large screen ELDs intended for consumer entertainment, color quality and pixel density may be emphasized. Testing and sorting of nixels facilitates the custom design and manufacture of ELDs in response to application specifications.

Categorizing nixels also allows a manufacturer to incorporate a group of relatively homogeneous nixels in a single display. A pixel surrounded by superior pixels can be distracting to the observer, and detrimental to the overall ELD performance. However, the same pixel surrounded by pixels of generally the same quality is no longer distracting. Thus, an important factor in ELD appearance is the homogeneity of the ELD pixels. By sorting and grouping nixels according to characteristics, relatively homogenous collections of nixels are compiled. A manufacturer can then use nixels from a homogeneous group to produce an ELD.

A further aspect is the ability to label or grade a display based on the quality of the nixels included therein. For example, an ELD comprising nixels of a premium grade can be identified as a gold level display, while an ELD comprising nixels of a slightly lower grade can be identified as a silver display. In addition, by knowing the nixel characteristics, nixels that vary from the norm can be placed around the display periphery so as to be less noticeable to a viewer.

One exemplary method of producing a nixel-based ELD is shown by method 1400 in FIG. 14. At block 1402, at least one desired nixel characteristic is determined. As mentioned previously, electrical and/or mechanical attributes can be used to characterize a nixel, and can consequently be used as a basis for selecting a nixel to produce an ELD for a particular application. At block 1404, a nixel satisfying the designated one or more characteristics is selected from a quantity of nixels. Nixels can be maintained in homogeneous groups, so that a nixel satisfying the designated requirements can easily be located and retrieved. At block 1406, the retrieved nixel is incorporated into an ELD structure.

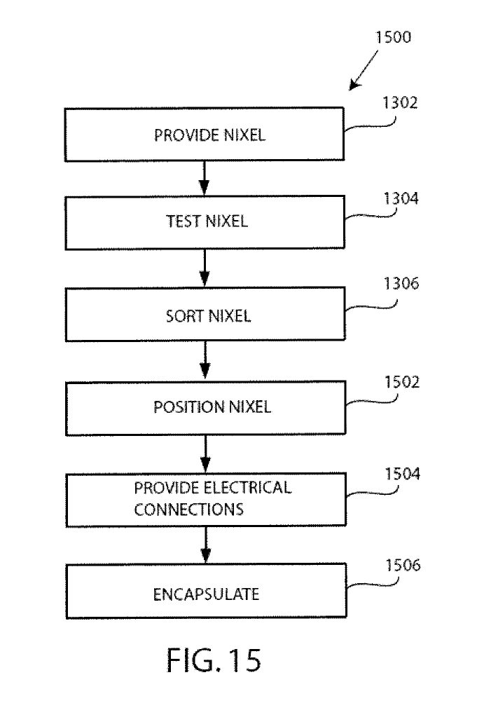

FIG. 15 shows a further method 1500 of the invention. Blocks 1302, 1304, and 1306 have been described earlier in reference to method 1300, so will not be addressed again here. After the nixels have been tested and sorted, they can be positioned on an ELD support structure at block 1502, provided with electrical connections at block 1504, and encapsulated at block 1506.

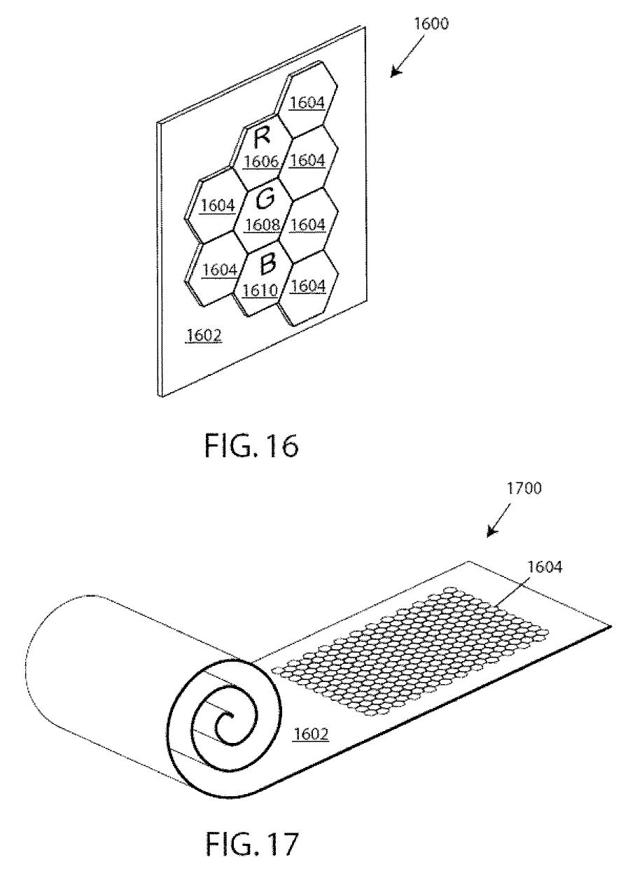

Exemplary embodiments of an ELD made in accordance with the aforementioned methods are shown in FIGS. 16 and 17. FIG. 16 shows an ELD 1600 comprising a support structure 1602 and a plurality of nixels 1604, where the nixels 1604 may include a blue nixel 1610, a green nixel 1608, a red nixel 1606, or other colored nixel characterized by a phosphor layer that emits a particular color of light when subjected to an electric field. The nixels shown in FIG. 16 have a hexagonal shape, but could be variably shaped as discussed previously herein. As shown in FIG. 16, a red nixel 1606, green nixel 1608, and blue nixel 1610 can be placed together in a desired pattern. The support structure 1602 can be any material adapted to receive nixels and provide support for an ELD. In the exemplary embodiment shown in FIG. 17, the support structure 1602 is a flexible material such as a polymer sheet upon which a plurality of nixels 1604 are selectively positioned to form a flexible ELD 1700.

As discussed previously, nixels can be selectively arranged on a supporting material in predetermined manner to achieve a desired result, and can be selected and positioned according to electrical and/or mechanical characteristics. Furthermore, colored nixels of the invention can be variably arranged to form color patterns. For example, for a first exemplary ELD, it may be desirable to populate an ELD with three-color nixel groups, so groups comprising a red, a blue, and a green nixel can be arranged along the surface of an ELD support material. For a second exemplary ELD, it may be desirable to form five-nixel color groups, in which case a green, a red, two yellow, and a blue nixel may be included. Color patterns can be customized to address consumer applications and desires. For example, it may be desirable to have an ELD composed of a plurality of color sectors. A blue sector can be made by positioning a plurality of blue nixels in a defined area of the ELD. Likewise, a green sector can be made by positioning a plurality of green nixels within a defined ELD area. Embodiments of the invention provide a plethora of nixel-patterning options, so that ELD performance can be optimized for a particular application. The methods of the invention easily accommodate ELF) design changes without requiring machinery to be retooled or the nixel manufacture process to be altered. New designs can be implemented simply by adjusting the nixel placement patterns.

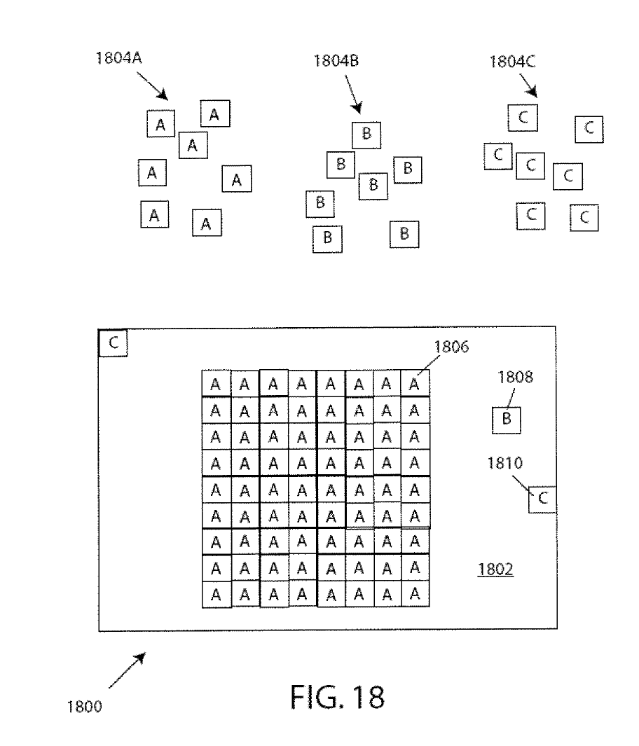

In addition to providing color pattern flexibility, the methods of the invention allow selective nixel placement according to nixel quality category. Referring to FIG. 18, an ELD 1800 is shown comprising a support structure 1802 and a plurality of nixels of varying quality categories that are sorted into groups having like characteristics. A first quality nixel 1806 is represented by a square with the letter A and is sorted and grouped into grouping 1804A, a second quality nixel 1808 is represented by a square with the letter B and is sorted and grouped into grouping 1804B, and a third quality category nixel 1810 is represented by a square with the letter C and is sorted and grouped into grouping 1804C. As shown in FIG. 18, first quality nixels 1806 can be used to form a homogeneous group in the center of the ELD 1800 which is typically more noticeable to a viewer than the edges of the ELD. By placing a homogeneous nixel group in the center of the display, there will be no nixel that will distract the viewer by providing a contrasting appearance relative to adjacent nixels. However, since contrasting nixels are not as obvious to a viewer when they are arranged toward the periphery of the ELD, second category nixel 1808 and third category nixel 1810 can be positioned as shown in FIG. 18, without significantly adversely affecting ELD appearance.

As discussed above, nixels may be arranged in a variety of desired patterns in accordance with desired characteristics of an ELD. Exemplary methods of incorporating nixels into an ELD will now be described. As also discussed above, when a sufficient electric field is provided to a nixel, the nixel emits light. Thus, when incorporating a nixel into an ELD, it is not only desirable to secure the nixel to the ELD but also to establish an electrical connection between the nixel and conductors of the ELD so that a sufficient electrical field can be generated. It should be noted that while in the following exemplary embodiments the nixels are described as being electrically connected to a plurality of orthogonal row and column conductors of a display, it is contemplated that the conductors may be provided in other arrangements and that the nixels may be incorporated into an ELD by a variety of methods.

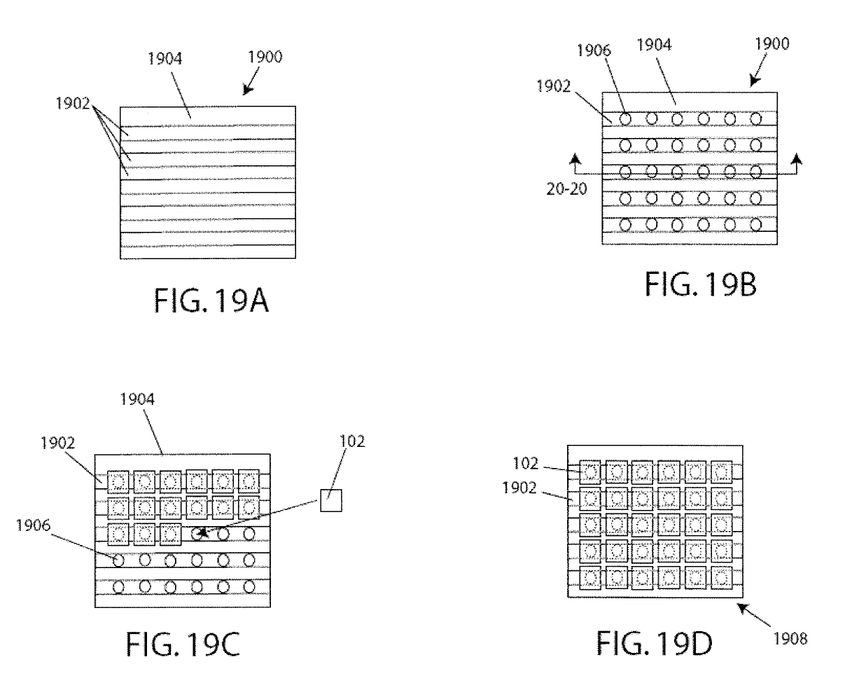

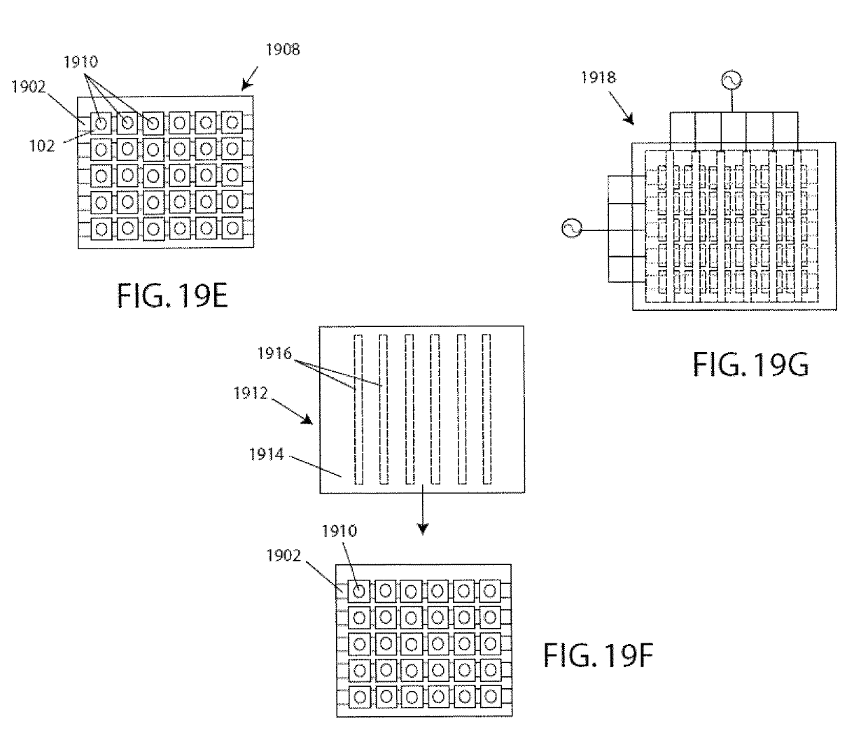

Turning to FIGS. 19A-19G, there is shown a first exemplary method of incorporating nixels 102 into an ELD. As shown in FIG. 19A, a row conductor structure 1900 is provided having a plurality of spaced apart conductors 1902 that serve as row electrodes in a completed ELD. In this example, the row conductor structure 1900 includes a flexible row conductor substrate 1904 comprising a polymer sheet. The row conductors 1902 can be gold strips provided on the surface of the conductor substrate 1904 which have a thickness of about nm, a width of about 1 mm and spaced about 0.24 mm apart. The row conductors 1902 are arranged so as to provide an electrical connection with a plurality of nixels incorporated in an ELD. It is contemplated that the row conductor substrate 1904 may be made of a variety of other materials, such as nickel or aluminum. Likewise, it is contemplated that the row conductors 1902 may be made of other conductive material such as BAYTRON® conductive polymer or silver. The row conductors 1902 may be provided on the row conductor substrate 1904 by a variety of methods such as inkjet printing. Alternatively, the row conductors 1902 may comprise a conductive tape adhered to the row conductor substrate 1904 and having an adhesive surface adapted to adhere to a nixel 102.

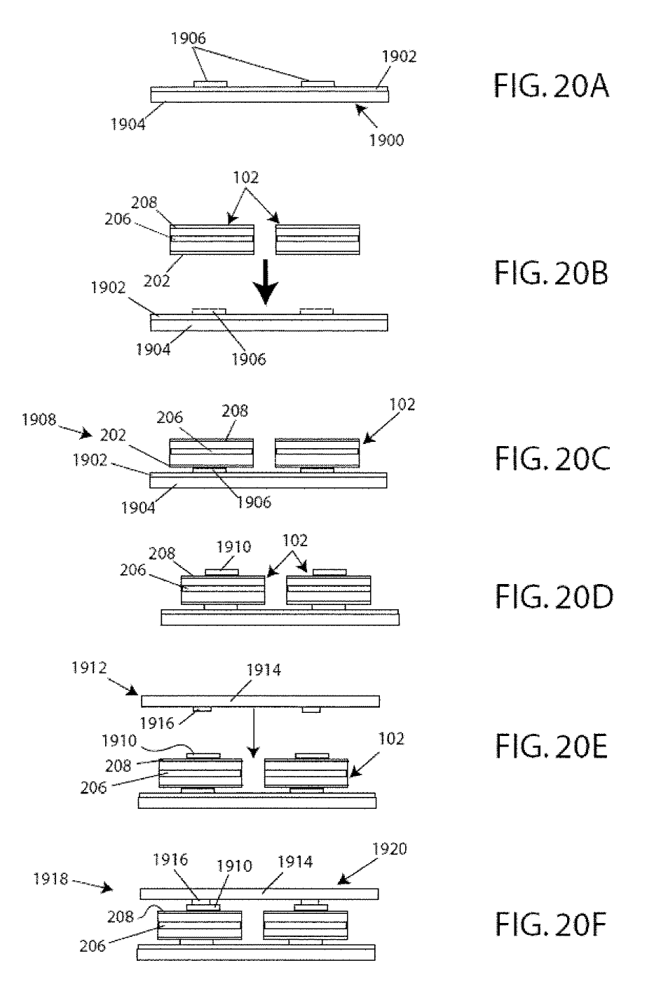

As shown in FIGS. 19B and 20, a conductive adhesive 1906 may be provided on the row conductors 1902 so that nixels 102 may be coupled thereto. By way of example and not limitation, silver paint, conductive tape, conductive epoxy, or other conductive adhesives may be used. The adhesive 1906 may be provided in a pattern according to a desired arrangement of the nixels 102 that are to be incorporated in the display. In this embodiment, the adhesive 1906 is applied to the row conductors 1902 but it is contemplated that the adhesive 1906 could be provided on the nixels 102. The adhesive 1906 may be applied by a variety of means such as printing or depositing.

As shown in FIGS. 19C and 20B, nixels 102 having a lower electrode 202 and an upper electrode 208 may be provided atop the conductive adhesive 1906 so that the lower electrode 202 of the nixels 102 contacts the conductive adhesive 1906 and the nixels 102 are coupled to the row conductors 1902 so that an electrical connection is established between the nixel lower electrode 202 and the row conductors 1902. This arrangement is shown in the panel 1908 shown in FIGS. 19D and 20C. In this exemplary embodiment, the nixels 102 are shown as generally rectangular in shape and oriented with the upper electrode 208 up so that the phosphor layer 206 of the nixel 102 is generally parallel to the planar row conductor 1902. This allows the emitted EL from the phosphor layer 206 to be visible through the top transparent upper electrode 208.

It is further contemplated that the nixels 102 may be arranged in desired patterns as discussed above in accordance with the particular qualities of individual nixels 102 such as quality, color point, etc. For example, nixels 102 of the invention can be positioned on the row conductor structure 1900 by using an electronic pick and place machine (not shown), commonly used in the electronics manufacturing industry, such as the ESSEMTEC® pick-and-place machine. A typical pick-and-place machine allows placement of variably sized electronic components on variably sized substrates to produce printed circuit boards. In general, electronic components maintained on tapes, trays or sticks are selected by the pick-and-place machine and then positioned on a substrate in a computer-controlled process. The process allows specific orientation and positioning along x-y- and z-axes. Components are held in position by solder paste that is either applied to the substrate prior to component placement, or applied to the individual components during the placement process. A similar process can be used to position nixels 102 on an ELD support material. Nixels can be loaded onto reels or trays from which they can be accessed and selected by the machinery. The pick and place machine can be computer programmed to accurately position the nixels 102 on a row conductor structure 1900 or other ELD support material. As discussed above, nixels 102 can be attached to the row conductor structure 1900 by using a conductive adhesive 1906 that is either applied to the row conductor structure 1900 or to the nixels 102 themselves. In the exemplary embodiment discussed above, the row conductor structure 1900 is a flexible polymer sheet and the nixels are glued thereto but the row conductor material could be any suitable conductive material. To assist the pick and place machine in properly orienting the nixels 102 it is contemplated that a nixel 102 may have a non-symmetrical shape so that the orientation of the nixel 102 can be readily determined. For example, the nixel 102 may have a protrusion located at a particular location on the nixel to assist the pick and place machine in orienting the nixel so that the upper electrode 208 of the nixel is upward to couple with a column conductor and the lower electrode 202 of the nixel 102 downward so as to couple with row conductors 1902 of an ELD.

The nixels 102 may also be placed on a row conductor structure 1900 using machinery (not shown) commonly employed in the textile industry to embellish fabrics with beads, sequins, and other decorative items. The typical machine used in the textile industry has a drum on which beads or other items are positioned. The drum is then rolled over a piece of fabric, depositing and gluing the items in a desired arrangement on the cloth or other material. Similarly, nixels 102 can be arranged and oriented on a machine drum. An adhesive 1906 such as conductive tape, glue paint or epoxy can be applied to the nixels 102 so that when the drum (not shown) is rolled over the row conductor structure 1900, the nixels are arranged and attached to the support in a desired arrangement.

Having coupled the nixels 102 to the row conductor structure 1900 and established electrical connection between the nixels 102 and row conductors 1902 an electrical connection may also be made between the upper electrode 208 of the nixels 102 and column conductors of a display. As shown in FIGS. 19E and 20D, a conductive adhesive 1910 may be applied to the upper electrode 208 of the nixels 102. In this case, the conductive adhesive 1910 may be transparent such as transparent conductive tape so as to allow for light emission from the nixel 102 through the adhesive 1910. The conductive adhesive 1910 may be applied in a similar manner as that discussed above in connection with the conductive adhesive 1906 used for coupling the nixels 102 to the row conductors 1902.

As shown in FIGS. 19F and 20E, a column conductor structure 1912 may include a column conductor substrate 1914 in the form of a flexible polymer sheet having a plurality of spaced apart column conductors 1916. The column conductors 1916 may correspond to the arrangement of the nixels 102 and the row conductors 1902 in the panel 1908 so that there is an overlap of a row conductor 1902 and column conductor 1916 at each nixel 102 so that a desired electric field may be generated at the nixels 102. The column conductor support structure 1912 may be provided atop the nixels 102 in a manner similar to that discussed above in connection with the row conductor substrate 1900 so that the column conductors 1916 are coupled to and establish an electrical connection with the upper electrodes 208 of the nixels 102 (FIG. 19F).

Preferably, the column conductors 1916 are transparent to allow for viewing of EL emitted from the nixels 102. One transparent conductor that may be used is indium tin oxide (ITO) which may be printed on the column conductor substrate 1914. In the exemplary embodiment shown in FIGS. 19E and 20D the conductive adhesive 1910 is applied to the nixels 102 but it is contemplated that a conductive adhesive may be applied to the column electrodes 1916 and/or the column conductor substrate 1914.

An advantage of using the row conductor structure 1900 and the column conductor structure 1912 is that the row conductor structure 1900 and the column conductor structure 1912 may be used to encapsulate the nixels 102. For example, the row conductor structure 1900 and column conductor structure 1912 may be vacuum sealed to provide a sealed ELD.

The intersection of the areas of any one row conductor 1902 and any one column conductor 1916 at a nixel 102 constitutes an EL pixel that may be illuminated by the generation of an electrical field at the overlap of the row 1902 and column 1916 conductors. Thus, any individual pixel in the ELD display may include one or more nixels 102. The nixels 102, row conductor structure 1900, and column conductor structure 1912 define an ELD display panel 1918. Application of an effective voltage between the two electrode layers produces an electric field above a threshold voltage to induce electroluminescence in the phosphor layer 206 of the nixels 102. Various methods can be used to address the particular nixels 102 in the display. For example, matrix addressing or some other addressing technique. It will be appreciated that the display electrodes may be provided in other arrangements. It should also be recognized that one nixel, multiple nixels, or a portion of a nixel may be subjected to an electric field (FIG. 19G) and thus define a pixel 1920 of the display (FIG. 20F).

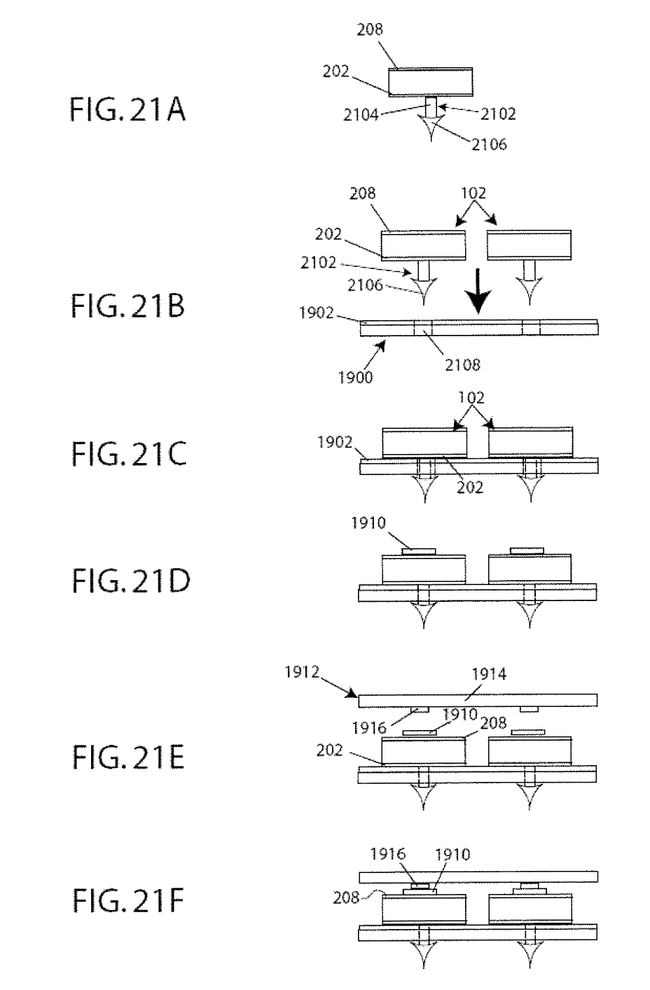

FIGS. 21A-21F show another exemplary method of incorporating modular nixels 102 into an ELD in which nixels 102 are mechanically coupled to a support structure. As shown in FIG. 21A, a nixel 102 is provided with a coupler 2102 that is adapted for coupling the nixel to a support material. In this exemplary embodiment the coupler 2102 comprises an extension 2104 having a barb 2106. The coupler 2102 may be made of ceramic and provided on the nixel by an automated punch machine.

As shown in FIG. 21B, a row conductor structure 1900 can include a plurality of row conductors 1902, and a plurality of apertures 2108 adapted to receive the extensions 2104. As shown in FIGS. 21B-C, the nixel 102 may be forced downward toward the row conductor support structure 1900 to drive the coupler 2102 through the lower aperture 2108 so that the barb 2106 protrudes from the lower surface of the row conductor structure 1900. The barb 2106 couples the nixel 102 to the row conductor structure 1900 so that the lower electrode 202 is in contact with the row conductor 1902. In addition, the barb 2106 prevents displacement or removal of the nixel 102 from the row conductor structure 1900. As shown in FIGS. 21D-F, the column electrodes may then be provided in a similar manner to that discussed above with regard to FIGS. 20D-F.

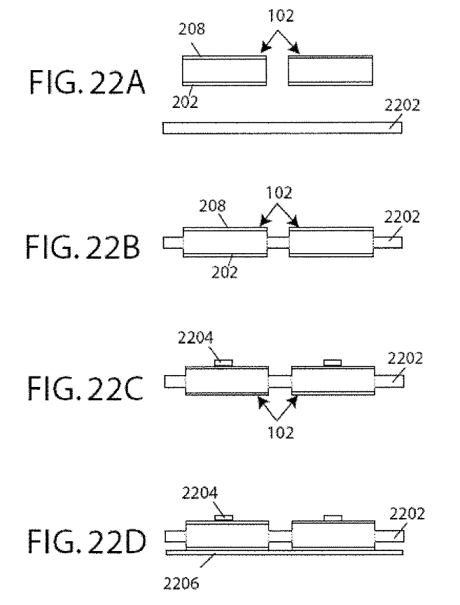

In a further embodiment, a flexible polymer can be heated to allow the nixels 102 to be embedded to a predetermined depth in a polymer. When the polymer cools, the nixels are maintained in position, obviating the need for an adhesive. Row and column conductors may then be provided on the upper 208 and lower 202 electrodes of the nixel 102. For example, as seen in FIG. 22A, a supporting material 2202 comprising a polymer sheet may be heated so that a plurality of nixels 102 may be embedded in the supporting material 2202 in such a manner that upper 208 and lower 202 electrodes of the nixels 102 protrude from the polymer sheet 2202 (FIG. 22B). This may be accomplished using a polymer film having a thickness of about 20-50 μm. Column conductors 2204 (FIG. 22C) and row conductors 2206 (FIG. 22D) may then be deposited on the upper 208 and lower 202 electrodes of the nixel 102 by various means such as, but not limited to, printing, sputtering, and sol gel deposition. It should be noted that other methods of providing row and column electrodes may be employed and that the various techniques described herein may be used in various combinations. It is further noted that the invention is not limited to the use of flexible substrates, as other transparent materials can also be used, including glass and plastics.

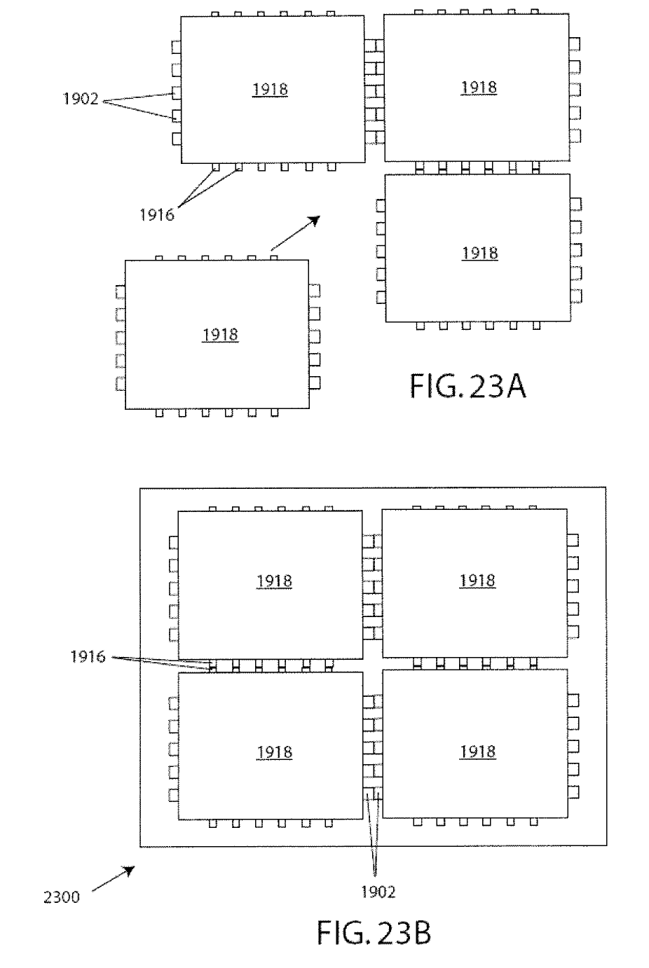

Referring to FIGS. 23A and 23B, after the modular nixels 102 are incorporated into panels 1918, the panels 1918 can be aligned and joined to form a scalable ELD 2300 of desired dimensions that may then be encapsulated to protect the ELD. In an exemplary embodiment the ELD is encapsulated in a weatherproof polymer.

Additional embodiments of the conductors and/or conductive adhesives introduced above (hereinafter referred to sometimes as “front contacts”) for electrically connecting the top electrodes of the nixels will now be discussed in more detail. It will be appreciated that these front contacts may be applied not only to the top or emissive electrodes of the nixels, but they may generally be applied to any external electrical connection between nixels or other electroluminescent elements. It will also be appreciated that the nixels described above for pixels or sub-pixels may be embodied in many variations without departing from embodiments of the invention. For example, other substrates may be utilized instead of the above-described ceramic dielectrics composed of barium titanate, BaTiO₃ (BT), barium strontium titanate, Ba_{0.5}Sr_{0.5}TiO₃ (BST). According to other embodiments of the invention, the nixels may be formed using a silicon substrate, a glass substrate, or other substrate. For example, a nixel may include a silicon substrate, a bottom electrode (e.g., formed of TiW, ITO, etc.), a phosphor (e.g. SrS-based phosphor) layer, and a top electrode. The nixel may also include optional charge injection layers between the back electrode and the phosphor and/or between the phosphor and the top electrode. According to another embodiment, the nixel may be a thin-film laminar stack that includes a substantially transparent top electrode, which may be ITO deposited on a transparent substrate such as glass. An electroluminescent phosphor layer may then be sandwiched between the front and rear dielectric or charge injection layers, all of which may be deposited behind the top electrodes. A rear electrode may then be deposited on the side of the rear dielectric layer opposite the phosphor. Accordingly, it will be appreciated that the nixels and stackups for the nixels have been described above for illustrative purposes only, and that various embodiments of nixels or other electroluminescent elements may be utilized with the front contacts described herein.

Moreover, these other electroluminescent elements that may be utilized with the front contacts may include electroluminescent chips and elements of various shapes and sizes, including spherical shapes. Examples of spherical shapes have been described as sphere-supported thin film phosphor electroluminescent (SSTFEL) devices, as described in WO 2005/024951 A1, published Mar. 17, 2005, and entitled “Sphere-Supported Thin Film Phosphor Electroluminescent Devices.” Accordingly, while the examples of front contacts below may be illustrated using exemplary nixels, these front contacts likewise would apply to other electroluminescent chips and elements as well.

By way of recap, the front contacts for the electroluminescent elements, including nixels, should be (i) visually and/or optically transparent, (ii) adhered to the top electrodes, (iii) flexible, and (iv) conductive. First, visual transparency does not necessarily mean that the front contacts are actually transparent to the naked eye. Instead, visual transparency may mean that the front contacts do not impede enough EL emitted from the nixels to be distracting or substantially noticeable at the desired viewing distance and/or angle. While some front contacts may actually be substantially optically transparent or semi-transparent, other front contacts utilized in accordance with embodiments of the invention may only be visually transparent.

Second, the front contacts should be adhered to the top electrodes of the nixels. The front contacts must adhere to the top electrodes of the nixels in order to maintain the electrical connections between or among nixels as the ELD is flexed (e.g., rolled) and unflexed (e.g., unrolled). Where the top electrodes of nixels comprise Indium Tin Oxide (ITO), certain adhesives or bonding pads described herein may be used for, or in conjunction with, the front contacts since ITO does not bond or conduct electrically well with some materials. Third, because the ELDs in accordance with embodiments of the invention are flexible, the conductors and/or adhesives associated with the front contacts likewise should be flexible or provide a degree of flexibility or stretchability. Finally, the column conductors and/or adhesives described herein for the front contacts should be conductive, thereby carrying enough voltage at the desired current and frequency to induce electroluminescence in the phosphor layer of the nixels.

In accordance with an embodiment of the invention, the front contacts may be provided using a variety of methods, including the following: (i) transparent stackups with throughholes (ii) wire connections, (iii) conductive meshes, (iv) transparent conductors, and (v) inter-chip space wiring. Each of these illustrative methods for providing front contacts will be presented below according to the order presented above. It will be appreciated that other methods for providing front contact are available, including combinations of or variations of the methods described below. It will also be appreciated that while not illustrated below, one or more transparent protective, anti-glare, filtering, and/or polarizing layers may be provided for the nixels/front contacts.

(i) Transparent Stackups with Throughholes

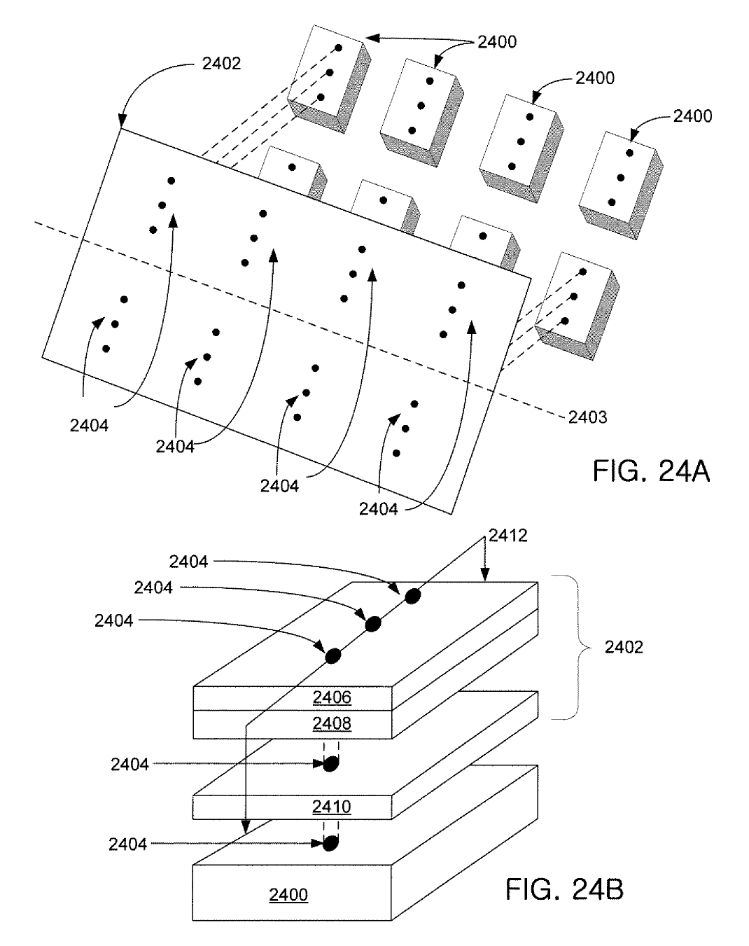

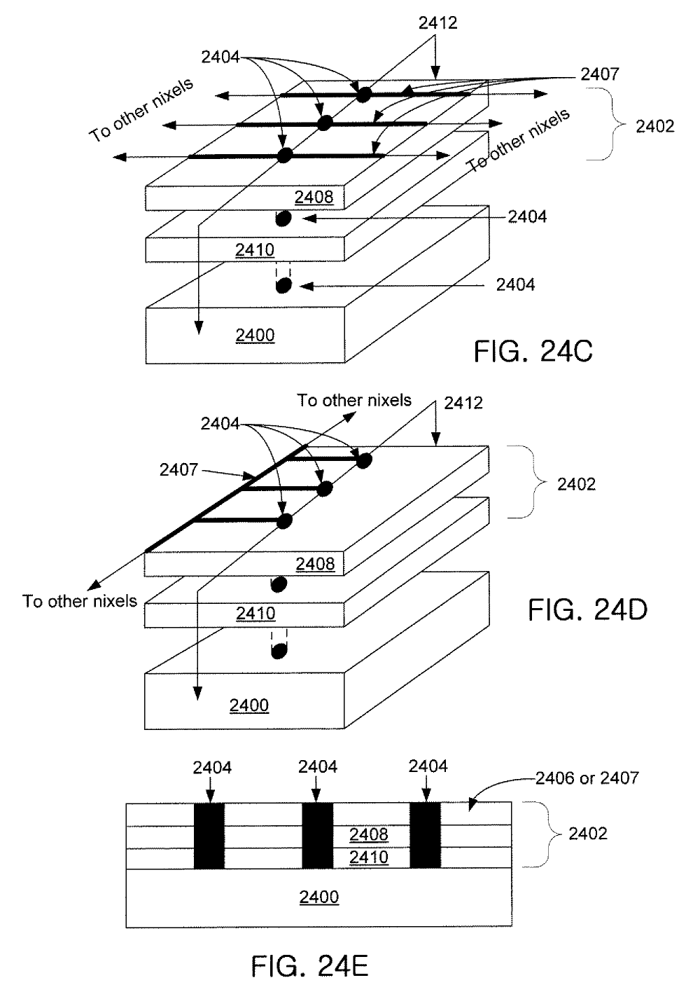

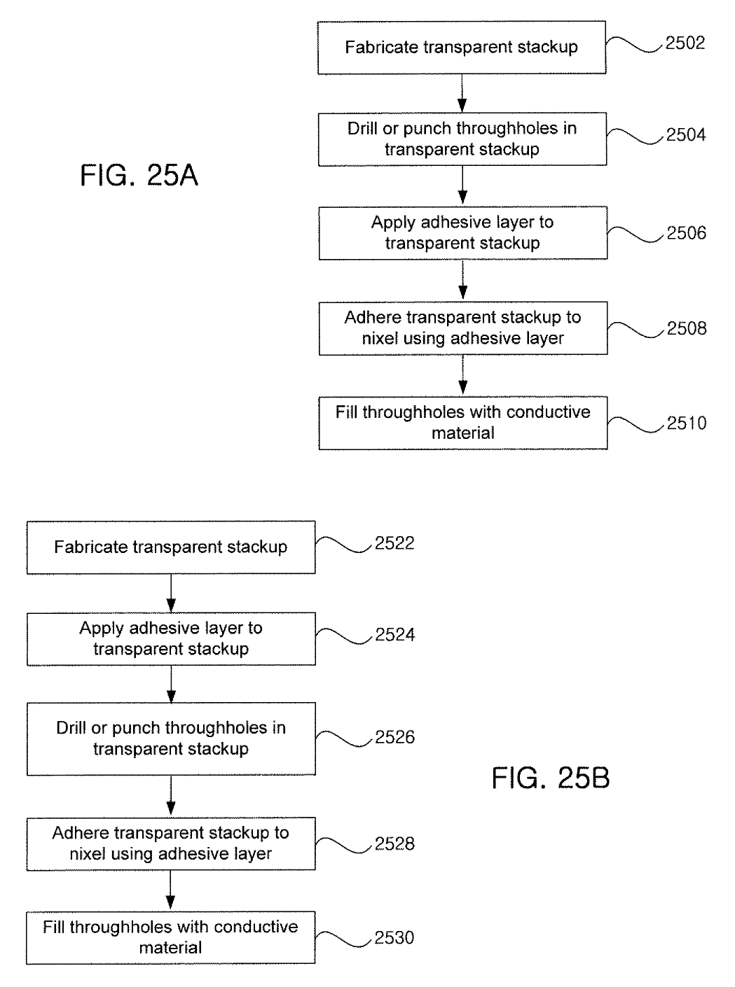

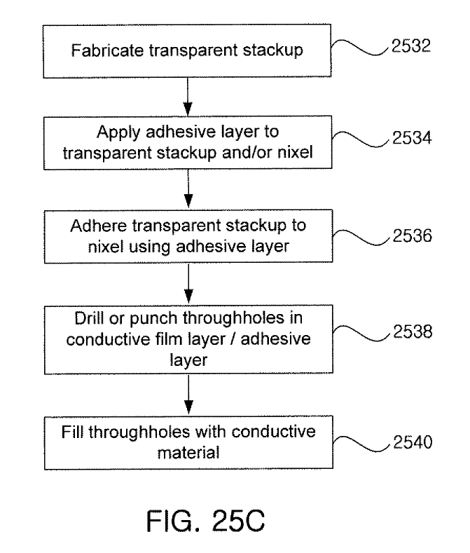

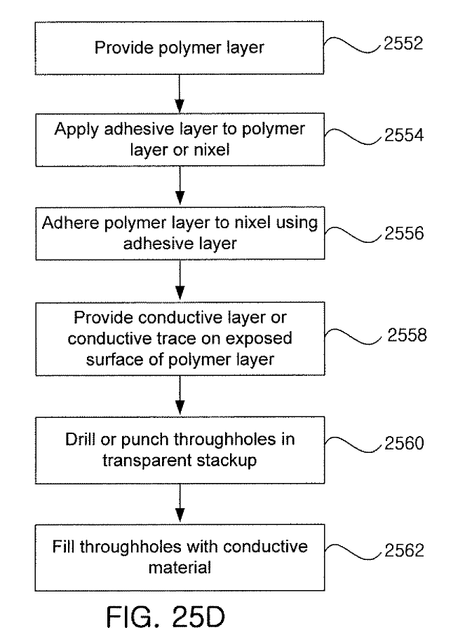

The use of transparent stackups with throughholes for the front contacts will now be described with respect to FIGS. 24A-24E and FIGS. 25A-25D. Referring to FIG. 24A for a perspective top view, there are a plurality of nixels 2400 and a transparent stackup 2402 with throughholes 2404. The transparent stackup 2402 may be arranged or aligned across one or more rows or columns of nixels 2400, and the throughholes 2404 may electrically connect the top electrode to the conductive layer(s) of the transparent stackup 2402. It will be appreciated that the transparent stackup 2402 may be initially applied to a plurality of rows or columns of nixels 2400 with the conductive layer subsequently being separated along one or more cut lines 2403 as necessary to electrically isolate particular rows or columns of nixels 2400. This cut may be performed mechanically or using laser energy. According to another embodiment of the invention, the transparent stackup 2402 may be applied to only the particular row of column of nixels 2400 to be electrically interconnected, such that no cut is necessary. Other variations, including the use of an embedded insulating strip may be utilized to electrically isolate particular rows or columns of nixels.

According to an embodiment of the invention, FIG. 24B illustrates a perspective frontal view of the transparent stackup 2402, as applied to the top electrode of the nixel 2400. In particular, in an embodiment of the invention, the transparent stackup 2402 may include a conductive layer 2406, a polymer layer 2408, and an optional adhesive layer 2410. It will be appreciated that the conductive layer 2406 may be formed of PEDOT (Poly(3,4-ethylenedioxythiophene), such as H. C. Starck's Baytron®), ITO, inherently conductive polymers (ICP), substantially transparent organic films, or substantially transparent nano-structure-based (e.g., carbon nanotube, silver nanofiber) conductive films. The conductive layer 2406 may be adhered to coated on, or otherwise formed on a flexible polymer layer 2408, which may be Mylar® or another thin, flexible, clear polymer. The polymer layer 2408 may generally be non-conductive, according to an embodiment of the invention. The optional adhesive layer 2410, which is likewise non-conductive, may be provided in some transparent stackups 2402 to further electrically isolate the thoughholes 2404 and/or provide a bond between the transparent stackup 2402 and the top electrodes of the nixels 2400. The adhesive layer 2410 may be formed of acrylic adhesives, silicone, polyurethane, double-sided tape, or other non-conductive adhesive materials. The throughholes 2404 may be filled or plated with conductive materials, perhaps transparent conductive materials, including conductive epoxy and loaded silicone. If loaded silicone is utilized, it can include conductive fillers such as ITO.

FIGS. 24C and 24D illustrate alternative embodiments of the transparent stackups 2402. In particular, FIGS. 24C and 24D illustrate conductive traces 2407 as the conductive layer formed on polymer layer 2408. In particular, according to an embodiment of the invention, FIG. 24C illustrates that each throughhole 2404 of a first nixel 2400 can be connected to a throughhole 2404 of a second nixel 2400 using one or more separate conductive traces 2407. These conductive traces 2407 may be formed using a variety of additive or subtractive processes on the polymer layer 2408, including etching, engraving, printing, milling, or other processes generally known in the art. According to another embodiment of the invention, FIG. 24D illustrates that a plurality of thoughholes 2404 of a first nixel 2400 may share an electrical connection with throughholes 2404 of a second nixel 2400 using conductive trace 2407 as an electrical bus. It will be appreciated that the placement and pattern of the conductive traces 2407 may vary according to different applications without departing from embodiments of the invention. It will also be appreciated that alternative embodiments of the invention may include the conductive traces 2407 formed on the conductive layer 2406 of FIG. 24B.

FIG. 24E illustrates a cross-sectional view of the transparent stackup 2402 of FIG. 24B, 24C, or 24D taken along axis 2412, according to an embodiment of the invention. As shown in FIG. 24E, the conductive layer 2406 and/or the conductive traces 2407 are electrically separated from the top electrode of the nixel 2400 by the polymer layer 2408 and the optional adhesive layer 2410. Instead, electrical connections are provided between the top electrode of the nixel 2400 and the conductive layer 2406 or the conductive traces 2407 using the conductive throughholes 2404. It will be appreciated that one or more throughholes 2404 may be provided for each nixel 2400, according to an embodiment of the invention. Indeed, the number and positioning of the throughholes 2404 may depend on the portion or portions of the nixel 2400 that are to be illuminated, according to an embodiment of the invention.

Several exemplary methods for providing the transparent stackups 2402 as front contacts for the nixels 2400 will now be described with reference to FIGS. 25A-25E, according to exemplary embodiments of the invention. Referring to FIG. 25A, at block 2502, the transparent stackups 2402 may be fabricated to provide the polymer layer 2408 coated with the conductive layer 2406 and/or patterned with conductive traces 2407. For example, the transparent stackups 2402 may generally include those described with respect to FIGS. 24B-24D, including Mylar® coated with a conductive layer 2406 or patterned with conductive traces 2407. At block 2504, throughholes 2404 may be drilled, punched, or otherwise provided through the transparent stackup 2402. According to an alternative embodiment of the invention, blocks 2502 and 2504 may be combined in a single block, with the transparent stackup 2402 being formed using moulds or other patterns that already include the patterning for the throughholes 2404.

At block 2506 of FIG. 25A, an optional adhesive layer 2410 may be added to the transparent stackup 2402. According to an embodiment of the invention, the adhesive layer 2410 may be applied to the exposed polymer layer 2408 of the transparent stackup 2402. If the adhesive layer 2410 has been applied to the to entire polymer layer 2408, then any adhesive layer 2410 covering portions of the throughholes 2404 may be removed (e.g. using an air blower or other cleaning or removal process) before proceeding to block 2508. At block 2508, the transparent stackup 2402 with the throughholes 2404 may be adhered to the top electrode of the nixels 2400. Block 2508 may include a lamination or curing process that involves heat, light (e.g., U.V. light), and/or time, according to an embodiment of the invention. However, it will be appreciated that such a lamination or curing process may not be necessary where the adhesive layer 2410 is a double-sided tape. At block 2510, the throughholes 2404 may be filled with a conductive material to provide an electrical connection between the conductive layer 2406 and/or conductive traces 2407 and the top electrode of the nixels 2400. According to an embodiment of the invention, the process of block 2510 may include a sputtering, injection, or other filling process to fill the throughholes 2404. According to another embodiment of the invention, excess conductive material may be spread across the exposed surface of the transparent stackup 2402 and allowed to flow into the throughholes 2404. Once sufficient conductive material has been received into the throughholes 2404, the excess conductive material may be cleaned from the surface of the transparent stackup 2402 using polishing or other suitable removal techniques, thereby retaining the conductive materials within the throughholes 2404. Alternatively, a mask may be provided over the surface of the transparent stackup 2402 with holes lining up with the throughholes 2404 so as to allow the conductive material to penetrate into the throughholes 2404 without the need for cleaning of the surface of the transparent stackup 2402.

FIG. 25B illustrates a process similar to the one described above in FIG. 25A, except that the adhesive layer 2410 is added to the transparent stackup 2402 before providing the throughholes 2404. More specifically, at block 2522 of FIG. 25B, the transparent stackups 2402 may be fabricated to provide the polymer layer 2408 coated with the conductive layer 2406 or patterned with conductive traces 2407. In block 2524, the adhesive layer 2410 is applied to the exposed polymer layer 2408. Then, at block 2526, the throughholes 2404 are drilled, punched, or otherwise provided through the transparent stackup 2402 that includes the conductive layer 2406/conductive trace 2407, the polymer layer 2408, and the adhesive layer 2410. At block 2528, the transparent stackup 2402 with the throughholes 2404 may be then be adhered to the top electrode of the nixels 2400. At block 2530, the throughholes 2404 may be filled with a conductive material to provide an electrical connection between the conductive layer 2406 and/or conductive traces 2407 and the top electrode of the nixels 2400. It will be appreciated that the adhesive layer 2410 may act as a dam or spacer to prevent the conductive material from flowing to/shorting out nearby components.

FIG. 25C is likewise similar to FIG. 25A, except that the transparent stackups 2402 may be adhered to the top electrodes of the nixels 2400 prior to providing the throughholes 2404. Referring to block 2532, the transparent stackups 2402 may be fabricated to provide the polymer layer 2408 coated with the conductive layer 2406 or patterned with conductive traces 2407. At block 2534, the adhesive layer 2410 may be applied to either or both of the exposed surface of the polymer layer 2408 or the top electrode layer of the nixel 2400. At block 2536, the transparent stackup 2402 is adhered to the top electrode of the nixel 2400 using the adhesive layer 2410. Again, the lamination or curing processes associated with block 2536 may include heat, light, and/or time according to an embodiment of the invention. At block 2538, the throughholes 2404 may be drilled, punched, or otherwise provided (e.g., laser energy) through the transparent stackup 2402. The throughholes 2404 may then be filled with conductive material to provide an electrical connection between the conductive layer 2406 and/or conductive traces 2407 and the top electrode of the nixels 2400, as provided at block 2540.

It will be appreciated that yet further variations of the methods of FIGS. 25A-25C are available without departing from embodiments of the invention. For example, as illustrated in FIG. 25D, it will be appreciated that the conductive layer 2406 or patterned with conductive traces 2407 may be formed at a later point in the process. In particular, at block 2552, only the polymer layer 2408 of the transparent stackup 2402 may initially be provided. At block 2554, the adhesive layer 2410 may be applied to either or both of the polymer layer 2408 and the top electrode of the nixel 2400. At block 2556, the polymer layer 2408 may be adhered to the top electrode of the nixel 2400 using the adhesive layer 2410. The conductive layer 2406 and/or patterned conductive traces 2407 may then the provided on the exposed polymer layer 2408, as illustrated at block 2558. At block 2560, throughholes 2404 may be provided through the transparent stackup 2402. The throughholes 2404 may then the filled with conductive material to provide an electrical connection between the conductive layer 2406 and/or conductive traces 2407 and the top electrode of the nixels 2400, as illustrated at block 2562. Additional variations and/or substitutions of one or more blocks in FIGS. 25A-D are available without departing from embodiments of the invention. In addition, the order of the blocks provided for in FIGS. 25A-D are merely illustrative, and the ordering of the blocks may be altered without departing from embodiments of the invention.

(ii) Wire Connections

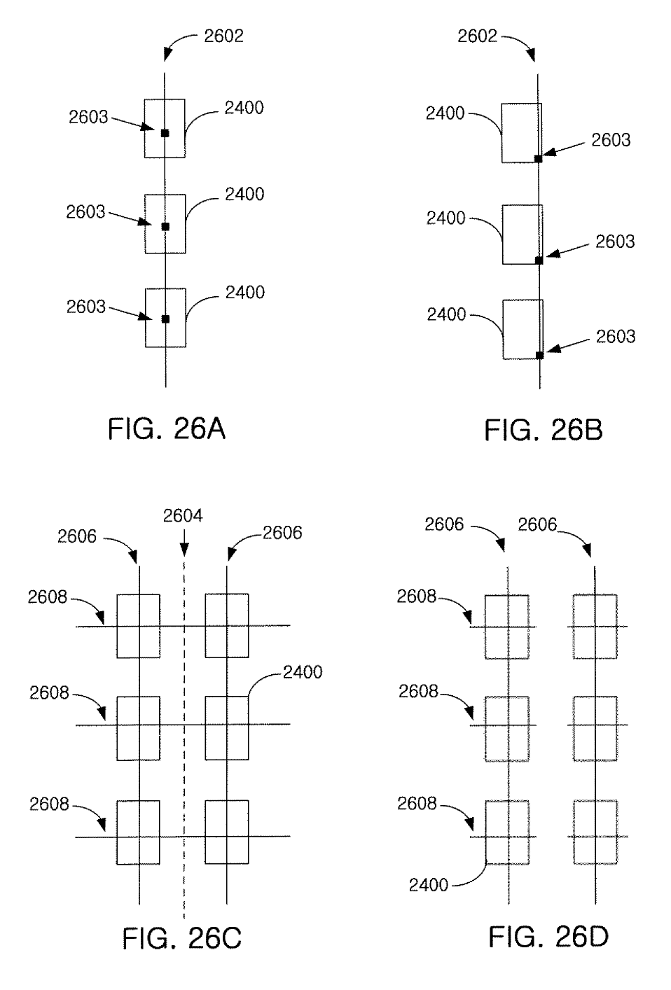

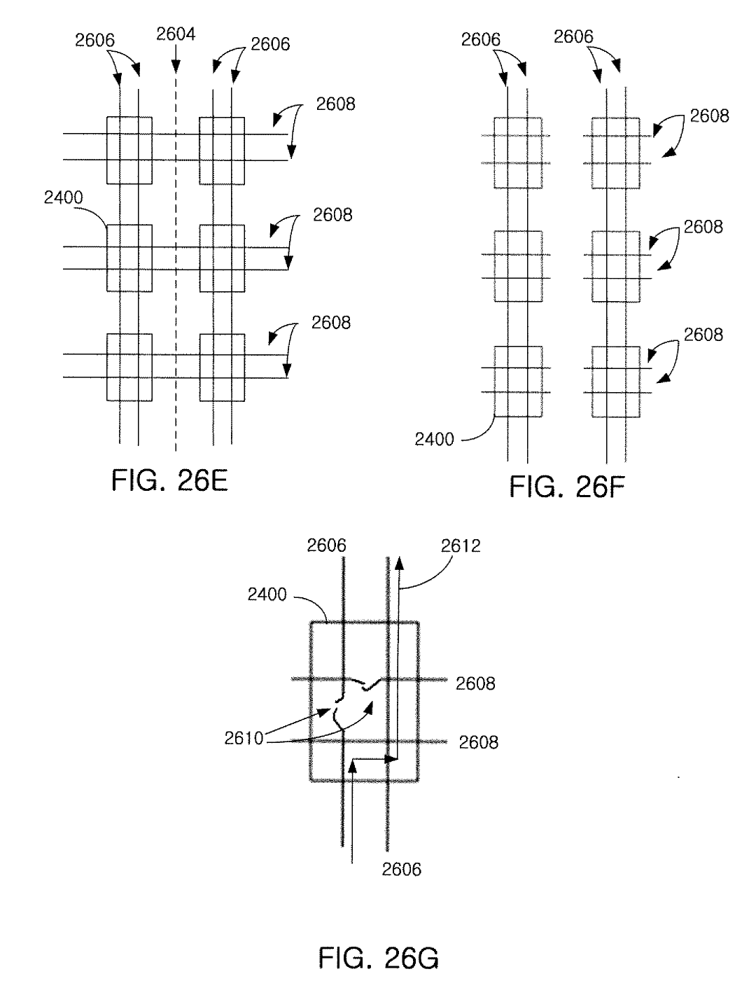

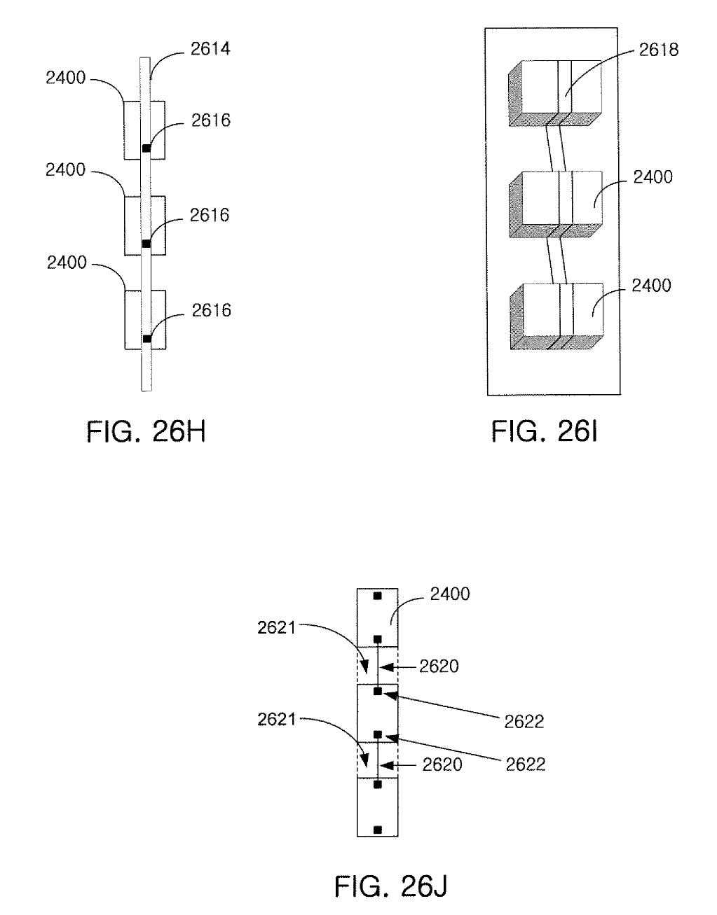

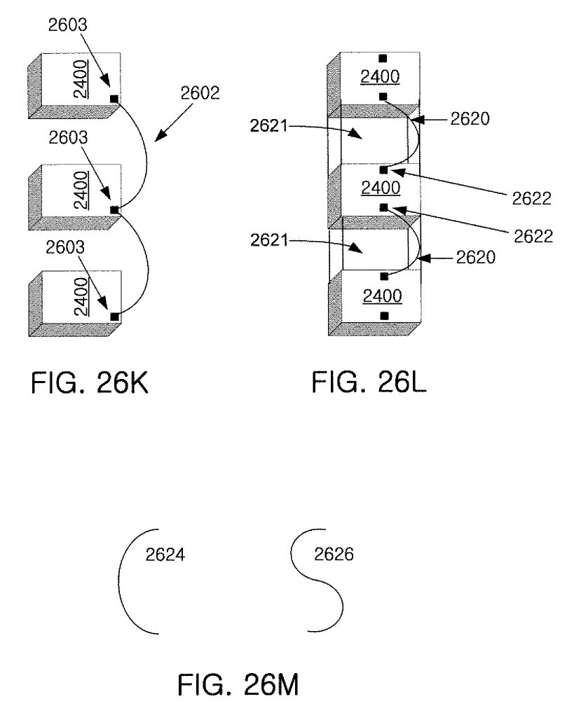

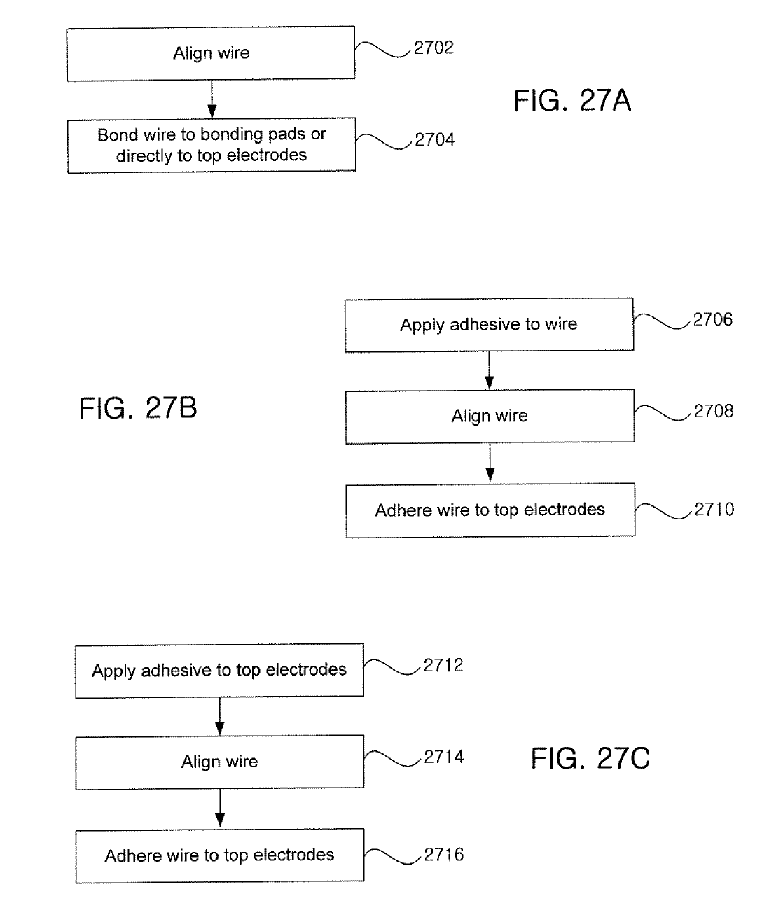

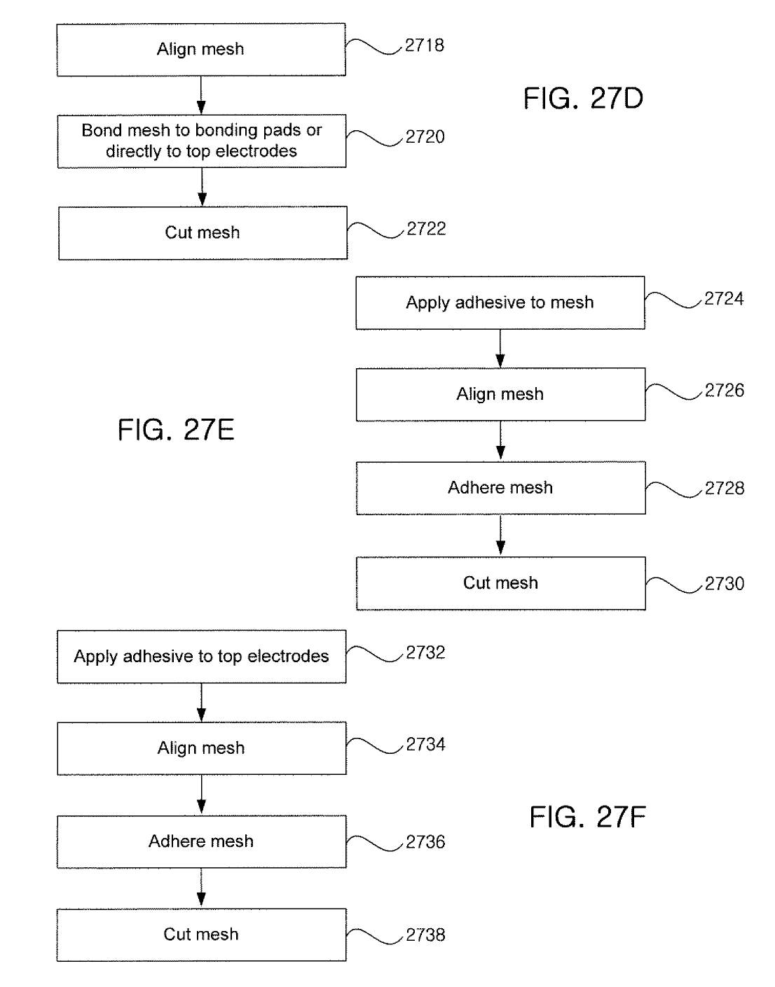

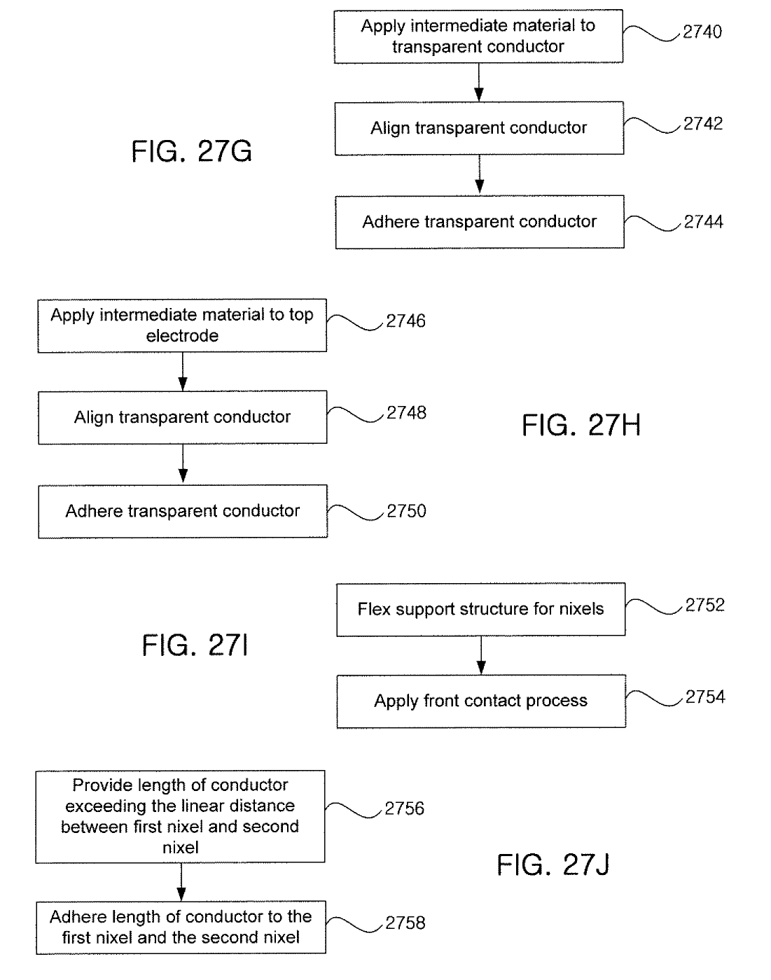

The use of wire connections for front contacts will now be discussed with respect to FIGS. 26A-26B and FIGS. 27A-27C. In particular, FIGS. 26A and 26B illustrates a row or column of nixels 2400 where the top (e.g., emissive) electrodes of the nixels 2400 may be electrically connected to each other using at least one wire 2602. The wire 2602 may be composed of a variety of electrically conductive materials, including gold, silver, aluminum, nickel, copper, steel, platinum, alloys, nano-structure-based materials (e.g., carbon nanotube, silver nanofiber), and the like. It will be appreciated that the wire 2602 may also contain some nonconductive materials as well to enhance certain desired front connection characteristics, including visual transparency, flexibility, and adhesiveness. Accordingly, the selection of the type of wire 2602, including its composition and thickness or gauge, may depend on a variety of factors, including (i) power requirements (e.g., current of 0-1A and voltage of 0-500V) for the nixels 2400, (ii) visual transparency requirements, (iii) ductility/malleability requirements associated with flexibility of the ELD, and (iv) adhesive or bonding requirements. Indeed, larger power requirements for operation of the nixels 2400 may require a higher gauge wire 2602 that may be balanced with the visual transparency requirements of the ELD. Likewise, ductility/malleability requirements may designate a particular material that is more ductile or malleable to enable an ELD to be flexed or rolled into its desired shape. For example, indium or another ductile/malleable material such as silicone may be added to the composition to improve ductility. Further, some conductive materials may not be appropriate for the wire 2602 due to their adhesive or bonding characteristics. Where the wire 2602 is to be bonded to or in electrical connection with top electrodes formed of Indium Tin Oxide (ITO), discussed above, only certain conductive materials are desirable since many materials have difficulty bonding directly to or conducting electrically with an ITO surface. Examples of conductive materials that may bond to or conduct electrically with ITO include gold, aluminum, titanium, chromium, and nickel, although other conductive materials are available as well.

With reference to FIGS. 26A and 26B, the connections 2603 between the wire 2602 and top electrode of the nixels 2400 may be provided according to several connection techniques, including wire bonding, conductive epoxy, solder, and a conductive adhesive/tape. If wire bonding is utilized for the connections 2603, then according to an embodiment of the invention, a bonding pad may be utilized as the intermediary conductive adhesive between the wire 2602 and the top electrode. For example, for an ITO top electrode, the bonding pad may be a Cr/Au stack. The chromium portion of the bonding pad may be bonded to the wire 2602 while the gold portion may be bonded to the ITO top electrode. Likewise, according to another embodiment, the bonding pads may be formed of TiW/Au stacks. It will also be appreciated that aluminum, nickel, chromium, and/or titanium may be substituted for at least a portion of the gold in the bonding pads. Further, where the top electrode is not ITO, other materials may be utilized for the bonding pads, including one or more of aluminum, copper, and other materials according to the bonding characteristics of the top electrode material. According to an alternative embodiment of the invention, the bonding pads may not be necessary at all with wire bonding. Instead, the wire 2602 may bond directly to the top electrode when heat, pressure, and/or ultrasonic energy is applied in accordance with the wire bonding.

An exemplary method for wire bonding will now be discussed with further reference to FIG. 27A. As shown at block 2702, the wire 2602 may be aligned variously along the top electrodes of the nixels 2400. For example, referring back to FIG. 26A, the wire 2602 may be aligned centrally along the top electrodes while in FIG. 26B, the wire 2602 is aligned along an edge of the top electrodes. It will be appreciated that the wire 2602 may also be aligned to form a side connection 2603 for the top electrodes of the nixels 2400. Side connections 2603 may be preferable in some embodiments in order to maximize the EL emission from the top electrode of the nixel 2400. Once the wire 2602 has been aligned, then at block 2704, the wire 2602 can be bonded, perhaps using one or more of heat, pressure, and/or ultrasonic energy, to either the intermediary bonding pads or directly to the top electrodes of the nixels 2400. If intermediary bond pads are utilized, they may be small in size and/or located at a corner of the top electrode in order to maximize EL emission from the top of the nixel 2400.

As described above, the connections 2603 between the wire 2602 and top electrode of the nixels 2400 may be provided using a conductive epoxy, solder, and/or conductive adhesive/tape, which may generally be referred to as adhesives. These adhesives are not limited in application to the present illustration of wire connections, but may also be utilized with the conductive meshes and inter-chip-space wirings, as will be described below.

According to an embodiment of the invention, conductive epoxies used for the connections 2603 may include resin formulations with conductive fillers, including gold and silver. If solder is used for the connections 2603, then the solder may include some combination of tin and lead or may be an indium-based composition. Other fillers may be added to the solder, including gold, silver, copper, bismuth, indium, zinc, and antimony. As described above, indium may improve the ductility of the connection 2603. It will be appreciated that the solder may be composed of other materials and fillers without departing from embodiments of the invention. If conductive adhesive/tape is used for the connections 2603, then conductive adhesive/tape may be formed from one or more conductive polymers, including poly(acetylene)s, poly(pyrrole)s, poly(thiophene)s, poly(aniline)s, poly(fluorene)s, Poly(3-hexylthiophene), polynaphthalenes, poly(p-phenylene sulfide), and poly(para-phenylene vinylene)s. The conductive adhesive/tape may be in a beaded form or in a tape form, according to an embodiment of the invention.

According to an embodiment of the invention, the selection among wire bonding conductive epoxy, solder, and conductive adhesive/tape may be based upon the characteristics of the nixels 2400 and/or the resulting ELD. For example, wire bonding may be utilized for large area displays because of its reduced capacitance across long distances. Conductive epoxy may be utilized in displays that will be repeatedly flexed and for its rapid processing. Alternatively, solder may be utilized for its flowability. Finally, conductive adhesive/tape may be utilized for its processability and scalability in production.

Other exemplary methods for providing wire connections utilizing adhesives such as the above-described conductive epoxy, solder, or conductive tape will now be discussed with further reference to FIGS. 27B and 27C. As shown at block 2706 in FIG. 27B, the adhesive may be applied to at least a portion of the wire 2602. According to an embodiment of the invention, the adhesive may be applied to the entire length of the wire 2602 that contacts with the top electrode of the nixel 2400. Alternatively, the adhesive may be applied to one or more discrete portions of the wire 2602. It will also be appreciated that varying amounts and sizes of adhesives may be utilized without departing from embodiments of the invention. At block 2708, the wire 2602 with the adhesive is then aligned accordingly with respect to the top electrodes of the nixels 2400. For example, the wire 2602 may be aligned along a center or edge of the top electrodes. Once the wire 2602 with the adhesive has been properly aligned, it is adhered to the top electrodes of the nixels 2400, as indicated at block 2710. The adhering process at block 2710 may include curing or hardening the adhesive via application of heat, light (e.g., U.V. light), and/or time.

In an alternative embodiment of the invention illustrated in FIG. 27C, the adhesive may be applied to a portion of the top electrodes of the nixels 2400 instead of being applied to wire 2602. In particular, at block 2712 of FIG. 27C, the adhesive may be applied to a portion of the top electrodes of the nixels 2400. According to another embodiment of the invention, the adhesive may be applied to a corner of the top electrodes of the nixels 2400 to improve the visual transparency of such front contacts. It will be appreciated, that the adhesive may be applied to one or more portions of the top electrode, and in various sizes, without departing from embodiments of the invention. Once the adhesive has been applied, then at block 2714, the wire 2602 may be aligned appropriately across the plurality of nixels 2400. At block 2716, the wire 2602 may be adhered to the top electrodes of the nixels 2400. The adhering process of block 2716 may be similar to the adhering process of block 2710 discussed earlier, and will not be discussed further herein.

(iii) Conductive Meshes

Next the use of a conductive mesh for front contacts will now be discussed with respect to FIGS. 26C-26F and FIGS. 27D-27F. In particular, FIGS. 26C-26D illustrate a first exemplary embodiment of a conductive mesh while FIGS. 26E-26F illustrate a second exemplar embodiment of another conductive mesh. Generally, the conductive meshes may be formed of column wires 2606 and row wires 2608. According to an embodiment of the invention, the row wires 2608 may be substantially perpendicular to the column wires 2606. In an embodiment of the invention, these column wires 2606 and row wires 2608 may be formed of a composition similar to that specified for the wire 2602 in FIGS. 26A and 26B. Accordingly, the column wires 2606 and row wires 2608 may be composed of a variety of electrically conductive materials, including gold, silver, aluminum, nickel, copper, steel, platinum, alloys, nano-structure-based materials (e.g., carbon nanotube, silver nanofiber), and the like. Likewise, it will be appreciated that the column wires 2606 and row wires 2608 may also contain some nonconductive materials as well to enhance certain front connection characteristics, including visual transparency, flexibility, and adhesiveness. The selection of the composition and gauge for the column wires 2606 and row wires 2608 is similar to that described with respect to the wire 2602, and as such, will not discussed any further here.

With reference to FIGS. 26C-26D and FIG. 27D, a method of applying the conductive mesh to the top electrodes of the nixels 2400 will be described. At block 2718 of FIG. 27D, the conductive mesh may be aligned with the top electrode of the nixels 2400. For example, the conductive mesh can be unrolled over a configuration of nixels 2400. According to a first embodiment of the invention, in block 2720, one or more portions of the conductive mesh may be bonded to bonding pads on the top electrodes of the nixels 2400. As these bonding pads have been discussed earlier, the discussion will not be repeated here. However, according to a second embodiment of the invention, in block 2720, one or more portions of the conductive mesh may be bonded directly to the top electrodes of the nixels 2400. As discussed above, the bonding may include the application of one or more of heat, pressure, and/or ultrasonic energy. Once the conductive mesh has been bonded to the nixels 2400, the mesh can then be cut along one or more lines 2604 between rows or columns of nixels 2400 to electrically isolate adjacent nixels 2400 along a row or column, respectively. According to an embodiment of the invention, the cut along one or more lines 2604 may be performed mechanically or using laser energy. Other cutting instruments may be used to perform the cut along one or more lines 2604 without departing from embodiments of the invention. Referring back to FIG. 26D, the result of the cut along one or more lines 2604 is illustrated, where the top electrodes of the nixels 2400 in a particular row or column are electrically connected to form one or more front contacts.

According to an alternative embodiment of the invention, the conductive mesh may include column wires 2606 that are conductive, but row wires 2608 that are non-conductive. For example, row wires 2608 may be formed of an insulating material such a non-conductive polymer or plastic. Where the conductive mesh 2620 includes non-conductive row wires 2608, the conductive mesh may not require cuts along one or more lines 2604. Therefore, block 2722 may be eliminated without departing from embodiments of the invention.

FIGS. 27E and 27F illustrate methods of applying the conductive mesh to the top electrodes of the nixels 2400 using conductive adhesives. FIGS. 27E and 27F will likewise be discussed with reference to FIGS. 26C and 26D. As described above, the conductive adhesives may include conductive epoxy, solder, and conductive adhesive/tape. It will be appreciated that other adhesives may be utilized without departing from embodiments of the invention. Referring to block 2724 of FIG. 27E, the adhesive may be applied to one or more portions of the conductive mesh of FIG. 26C. Indeed, according to an embodiment of the invention, the adhesive may be applied to the entire conductive mesh. However, according to another embodiment of the invention, the adhesive may be applied to selective portions of the conductive mesh, perhaps only to those portion that will make contact with the top electrode of the nixels 2400. After the adhesive has been applied to the conductive mesh, then at block 2726, the conductive mesh may be aligned across the plurality of nixels 2400. The conductive mesh may then be adhered to the top electrodes of the nixels 2400, as illustrated at block 2728. As discussed earlier, the adhering process may include curing or hardening the adhesive via application of heat, light (e.g., U.V. light), and/or time. At block 2730, the conductive mesh of FIG. 26C may be cut along one or more lines 2604 to separate the electrically connected rows or columns of nixels 2400, as illustrated in FIG. 26D.

FIG. 27F illustrates a variation of FIG. 27E in which the adhesive may be applied to the top electrodes of the nixels in addition to or instead of the mesh. In particular, at block 2732, the adhesive may be applied to at least a portion of the top electrodes of the nixels 2400. As similarly described above, the mesh may be aligned at block 2734 and adhered at block 2736. Once the mesh has been adhered to the top electrodes of the nixels, then the mesh may be cut 2604 at block 2738 to separate the electrically connected rows or columns of nixels 2400.

FIGS. 26E and 24F illustrate alternative embodiments of the conductive mesh. In particular, FIG. 26E illustrates a conductive mesh that may have multiple column wires 2606 and/or row wires 2608 that overlap each nixel 2400. The processes for applying conductive meshes described in FIGS. 27D-27F also apply to the conductive mesh of FIG. 26E. Once, the conductive mesh of FIG. 26E has been cut along one or more lines 2604, the electrically connected rows or columns of nixels 2400 may be obtained, as illustrated in FIG. 26F.

It will be appreciated that the alternative conductive mesh of FIGS. 26E and 26F may provide electrical contact redundancy for the front contacts. In particular, as the ELD is flexed or unflexed according to use, one or more of the column wires 2606 and/or row wires 2608 may develop strains and break 2610, as illustrated in FIG. 26G. However, since conductive mesh of FIGS. 26E-26G may include multiple column wires 2606 and/or row wires 2608, one or more breaks 2610 may be compensated by utilizing any remaining paths 2612 for connecting the top electrodes of the nixels 2400.

(iv) Transparent Conductors

The use of transparent conductors for front contacts will now be discussed with respect to FIG. 26H and FIGS. 27G-27H. Referring to FIG. 26H, the transparent conductors 2614 may be visually and/or optically transparent, flexible, conductive material perhaps coated on none side of a clear substrate. According to an embodiment of the invention, the transparent conductor 2614 may be composed of PEDOT (such as H. C. Starck's Baytron®), ITO, inherently conductive polymers (ICP), silicone loaded with conductive fillers such as ITO (e.g., “loaded silicone”), substantially transparent organic films, or substantially transparent nano-structure-based (e.g., carbon nanotube, silver nanofiber) conductive films. The transparent conductor 2614 may also include a clear substrate, which may include Mylar® or other thin, flexible, clear polymer. It will be appreciated that a clear substrate may not be necessary for loaded silicone.

In addition, intermediate materials 2616 may in some embodiments be necessary to bond the transparent conductor 2614 to the top electrode of the nixels 2400. Examples of intermediate materials 2616 may include indium solder or conductive adhesive/tape. It will be appreciated that if loaded silicone is utilized for the transparent conductor 2614, then the intermediate material 2616 may not be necessary to adhere the loaded silicone to the top electrodes of the nixels 2400. Indeed, referring to FIG. 26I, an injection mechanism or printer may be used to directly apply the loaded silicone 2618 across the top electrodes (and between the spaces) of the nixels 2400. Alternatively, as described below, potting materials (e.g., polymers) may fill in the spaces between the nixels 2400, such that the loaded silicone may be applied within as single plane (instead of between the spaces) to electrically connect nixels.

FIGS. 27G and 27H illustrate methods for applying the transparent conductor 2614 to the top electrodes of the nixels 2400. Referring to FIG. 27G, at block 2740, the intermediate material 2616 may be applied as an adhesive to the transparent conductor. At block 2742, the transparent conductor 2614 having the intermediate material 2616 may be aligned among the plurality of nixels 2400. At block 2744, the transparent conductor 2614 may be adhered to the top electrodes of the nixels 2400. The adhering process at block 2740 may also include a curing process using heat, light (e.g., U.V. light), and/or time. It will be also be appreciated that transparent conductor 2614 may also be patterned or shaped using laser energy.

FIG. 27H illustrates an alternative embodiment to FIG. 27G in which the intermediate material 2616 may initially be applied to the top electrode of the nixels 2400, as illustrated at block 2746. Next, the transparent conductor is then aligned among the plurality of nixels 2400, as illustrated in block 2748. At block 2750, the transparent conductor 2614 may be adhered to the top electrodes of the nixels 2400.

(v) Inter-Chip Space Wiring

The use of inter-chip space wiring for front contacts will now be discussed with respect to FIG. 26J. In particular, as shown in FIG. 26J, there are plurality of nixels 2400 with flexible potting material 2621 in the spaces between the nixels 2400. The potting material 2621 may include a polymer or plastic material. In addition, in FIG. 26J, there is a conductor 2620 connecting a top electrode of one nixel 2400 to another top electrode of another nixel 2400. As shown, an end of the conductor 2620 may be connected 2622 to an edge of the top electrode of the nixel 2400 using wire bonding, conductive epoxy, solder, or conductive adhesive/tape. As conductor connections using wire bonding and conductive epoxy have been discussed in detail earlier with respect to FIGS. 26A-26B and FIGS. 27A-27C, the discussion will not be repeated here.

Still referring to FIG. 26J, according to an embodiment of the invention, the conductor 2620 may be a wire, in which case the wire may be a variety of electrically conductive materials, including gold, silver, aluminum, nickel, copper, steel, platinum, alloys, nano-structure-based materials (e.g., carbon nanotube, silver nanofiber), and the like. Where the wire is to be connected to ITO, perhaps an ITO top electrode, the wire may be composed of gold, aluminum, nickel, or another conductive material that can be bonded to or electrically connected with the ITO. According to another embodiment of the invention, the conductor 2620 may be formed from PEDOT (such as H. C. Starck's Baytron®), loaded silicone, substantially transparent organic conductive films, or substantially transparent nano-structure-based (e.g., carbon nanotube, silver nanofiber) transparent conductive films. If loaded silicone is utilized for the conductor, then an injection mechanism and/or printer may be utilized to apply the loaded silicone. Indeed, if the potting material creates a substantially level plane across the top electrodes, then the injection mechanism or printer may apply the loaded silicone within a single plane to connect the top electrodes.

FIGS. 26K and 26L illustrate that, in some embodiments, the wire 2602 or other conductor 2620 may be arched or otherwise coiled to allow the nixels 2400 to flex or otherwise move apart while maintaining an electrical connection in the flexed position. In particular, FIG. 26K is an exemplary perspective view of FIG. 26A or 26B while FIG. 26L is an exemplary perspective view of FIG. 26J. Referring to FIGS. 27I-J, there are exemplary methods for arching or otherwise coiling the wire 2602 or the conductor 2620, according to embodiments of the invention. It will also be appreciated that the exemplary methods of FIGS. 27I-J apply not only to wire connections and inter-chip space wiring, but also transparent stackups with throughholes, conductive meshes, and transparent conductors as well.

Referring to FIG. 27I, there is an exemplary method in which the supporting substrate for the nixels 2400 may be flexed (e.g., arched or bent) to the desired curvature before applying the front contact processes described herein. This allows the electrical connections for the top electrodes to be maintained as the substrate for the nixels 2400 is flexed (e.g., rolled). In particular, referring to FIG. 27I, at block 2752, the arcing or bending of the supporting substrate will separate the nixels 2400 to a linear and/or radial distance, perhaps a desired or maximum distance, thereby allowing a sufficient length of conductor to be utilized to connect the adjacent top electrodes of the nixels 2400. This desired or maximum distance may be determined based upon how much or how tightly the substrate for the nixels 2400 will be rolled or flexed during typical operation. Accordingly, once the supporting substrate has been arched or flexed, then one of the front contact processes described herein can be applied, as illustrated in block 2754.

Referring to FIG. 27J, according to another embodiment, the supporting substrate for the nixels 2400 can be left intact when performing front contact processes described herein. In particular, referring to FIG. 27J, at block 2756, the alignment of the wire may further include creating certain loops or coils to create excess length between the adjacent top electrodes of the nixels 2400. As an example. FIG. 26M illustrates an exemplary C-shape conductor/wire 2624 or an S-shape conductor/wire 2626 that may be used to bridge the top electrode of a first nixel 2400 to the top electrode of a second nixel 2400. At block 2758, the length of the conductor can then be adhered to the nixels 2400 that are to be connected.

Therefore, embodiments of the present invention may provide front contacts that are visually and/or optically transparent, adhesive to the top electrodes, flexible, and conductive. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for providing electrical connections for an electroluminescent display, comprising:
arranging a plurality of electroluminescent elements, wherein each electroluminescent element includes at least one top electrode, and wherein the electroluminescent elements are operable to emit electroluminescence through the top electrode;
providing a conductive layer, wherein the conductive layer is flexible and substantially transparent; and
adhering the conductive layer to a first top electrode of a first electroluminescent element of the plurality of electroluminescent elements and to a second top electrode of a second electroluminescent element of the plurality of electroluminescent elements.

2. The method of claim 1, wherein arranging a plurality of electroluminescent elements includes providing the electroluminescent elements on a supporting substrate, wherein the supporting substrate is flexible.

3. The method of claim 2, further comprising flexing the support substrate to separate the first electroluminescent and second electroluminescent elements to a distance before performing the step of adhering the conductive layer.

4. The method of claim 1, wherein the electroluminescent elements include one of nixels and sphere-supported thin film phosphor electroluminescent (SSTFEL) devices.

5. The method of claim 1, wherein the top electrodes of the electroluminescent elements are one of substantially flat and substantially spherical in shape.

6. The method of claim 1, wherein the first and second electroluminescent elements each include a bottom electrode, wherein the respective top and bottom electrodes sandwich at least one respective phosphor layer and at least one respective dielectric layer.

7. The method of claim 1, further comprising:
providing a substantially transparent, non-conductive polymer layer, wherein the conductive layer is provided on a surface of the substantially transparent, non-conductive polymer layer, and
forming throughholes through the conductive layer and the non-conductive polymer layer, wherein adhering the conductive layer includes filling the throughholes with conductive material such that the conductive material contacts the conductive layer and the first and second top electrodes.

8. The method of claim 7, wherein providing the conductive layer includes providing a patterned conductive trace on the substantially transparent, non-conductive polymer layer.

9. The method of claim 1, wherein the conductive layer is one of (i) one or more wires, (ii) a conductive mesh, and (iii) one or more transparent conductors.

10. The method of claim 1, wherein the conductive layer is a wire mesh and subsequent to adhering the wire mesh, the method further includes cutting the mesh between a row or column of electroluminescent elements.

11. The method of claim 1, wherein the conductive layer includes at least one of (i) Poly(3,4-ethylenedioxythiophene) (PEDOT), (ii) Indium Tin Oxide (ITO), (iii) an inherently conductive polymer (ICP), (iii) a substantially transparent organic film, and (iv) a substantially transparent nanostructure-based conductive film.

12. The method of claim 1, further comprising:
prior to adhering the conductive layer, depositing potting material in at least a portion of a space between the electroluminescent elements, wherein an upper surface of the deposited potting material is on a substantially same plane as the top electrodes of the electroluminescent elements.

13. An electroluminescent display, comprising:
a flexible support structure;
a plurality of electroluminescent elements arranged on the flexible support structure, wherein each electroluminescent element includes at least one top electrode, and wherein the electroluminescent elements are operable to emit electroluminescence through the top electrode; and
a conductive layer, wherein the conductive layer is flexible and substantially transparent and wherein the conductive layer is electrically connected to a first top electrode of a first electroluminescent element of the plurality of electroluminescent elements and a second top electrode of a second electroluminescent element of the plurality of electroluminescent elements.

14. The electroluminescent display of claim 13, wherein the conductive layer remains electrically connected to the first top electrode and the second top electrode when the supporting structure is rolled over itself.

15. The electroluminescent display of claim 13, wherein the electroluminescent elements include one of nixels and sphere-supported thin film phosphor electroluminescent (SSTFEL) devices.

16. The electroluminescent display of claim 13, wherein the top electrodes of the electroluminescent elements are one of substantially flat and substantially spherical in shape.

17. The electroluminescent display of claim 13, wherein the first and second electroluminescent elements each include a respective bottom electrode wherein the respective top and bottom electrodes sandwich at least one respective phosphor layer and at least one respective dielectric layer.

18. The electroluminescent display of claim 13, wherein the conductive layer is provided on a surface of a substantially transparent, non-conductive polymer layer, and wherein throughholes filled with conductive material are provided through the conductive layer and the non-conductive polymer layer, and wherein the filled throughholes electrically connect the conductive layer with the first and second top electrodes.

19. The electroluminescent display of claim 13, wherein the conductive layer is patterned to form a conductive trace on the substantially transparent, non-conductive polymer layer.

20. The electroluminescent display of claim 13, wherein the conductive layer is one of (i) one or more wires, (ii) a conductive mesh, and (iii) one or more transparent conductors.

21. The electroluminescent display of claim 13, wherein the conductive layer includes at least one of (i) Poly(3,4-ethylenedioxythiophene) (PEDOT), (ii) Indium Tin Oxide (ITO), (iii) inherently conductive polymer (ICP), (iii) a substantially transparent organic film, and (iv) a substantially transparent nanostructure-based conductive film.

22. An electroluminescent display, comprising:
means for arranging a plurality of electroluminescent elements, wherein each electroluminescent element includes at least one top electrode, and wherein the electroluminescent elements are operable to emit electroluminescence from the top electrode; and
means for electrically connecting a first top electrode of a first electroluminescent element of the plurality of electroluminescent elements to a second top electrode of a second electroluminescent element of the plurality of electroluminescent elements, wherein the means for electrically connecting is flexible and substantially transparent.
